(19) United States
(12) Patent Application Publication
(10) Pub. No.: US 2011/0217651 A1
(43) Pub. Date: Sep. 8, 2011

(54) IMAGE FORMATION METHOD AND IMAGE FORMATION APPARATUS

(75) Inventors: Hirofumi HAYATA, Tokyo (JP); Toshiyuki FUJITA, Tokyo (JP)

(73) Assignee: KONICA MINOLTA BUSINESS TECHNOLOGIES, INC., Tokyo (JP)

(21) Appl. No.: 13/036,087

(22) Filed: Feb. 28, 2011

(30) Foreign Application Priority Data
Mar. 8, 2010 (JP) 2010-050314

(51) Int. Cl. G03G 21/00; G03G 15/00

(52) U.S. Cl. 430/119.86; 399/159

(57) ABSTRACT

Disclosed is an image formation method comprising the steps of charging an organic photoreceptor by a charging device, the organic photoreceptor comprising a substrate and provided thereon, a photoreceptive layer and a protective layer in that order; imagewise exposing the charged organic photoreceptor by an exposure device to form an electrostatic latent image; developing the electrostatic latent image by a developing device to form a toner image, the developing device comprising a developer containing a toner; transferring the toner image to a recording medium by a transfer device; and then removing, by a cleaning device, a toner remaining on the organic photoreceptor from the organic photoreceptor, wherein the protective layer is formed by polymerization of a polymerizable composition containing a polymerizable compound with a polymerizable functional group, and wherein the toner contains an antioxidant.

This application is based on Japanese Patent Application No. 2010-050314, filed on Mar. 8, 2010 in Japanese Patent Office, the entire content of which is hereby incorporated by reference.

### FIELD OF THE INVENTION

The present invention relates to an image formation apparatus used for image formation according to an electrophotographic system and an image formation method.

### TECHNICAL BACKGROUND

In an electrophotographic photoreceptor, an inorganic photoreceptor employing Se, arsenic, an arsenic/Se alloy, CdS, ZnO, and the like has been replaced with an organic photoreceptor which is advantageous in productivity and the environment. An organic photoreceptor (hereinafter referred to simply as photoreceptor) employing various materials has been developed.

However, an organic photoreceptor is insufficient in abrasion resistance, and is likely to cause deterioration of the charge transport material and the like due to an active gas such as ozone or NOx occurring during the charging process, lowering of sensitivity, lowering of image density due to residual potential increase or image blurring.

In order to improve abrasion resistance of an organic photoreceptor, there has been proposed an organic photoreceptor with improved abrasion resistance property, in which a cross-linked and cured protective layer is provided (see, for example, Japanese Patent O.P.I. Publication No. 8-179541). However, when the abrasion resistance property of the protective layer is improved by increasing cross-linking density, the refreshing function of the photoreceptor surface is lowered, and the photoreceptor has a tendency to result in image blurring under high temperature and high humidity conditions during repeated operation.

So, in order to prevent image blurring, an attempt has been made in which an antioxidant is incorporated in a protective layer to solve the problem in abrasion resistance property and image blurring (see, for example, Japanese Patent O.P.I. Publication No. 2008-58779). However, the cured protective layer with high abrasion resistance does not maintain the oxidation preventing effect due to the antioxidant for a long time, resulting in image blur under high temperature and high humidity conditions on repeated operation.

### SUMMARY OF THE INVENTION

In view of the above, the present invention has been made. An object of the invention is to provide an image formation apparatus and an image formation method, which prevent image blur from occurring and improve a wear resistance property, even when an organic photoreceptor comprising a cured protective layer is employed.

The image formation method of the invention is featured in that it comprises the steps of charging an organic photoreceptor by a charging device, the organic photoreceptor comprising a substrate and provided thereon, a photoreceptive layer and a protective layer in that order; imagewise exposing the charged organic photoreceptor by an exposure device to form an electrostatic latent image; developing the electrostatic latent image by a developing device to form a toner image, the developing device comprising a developer containing a toner; transferring the toner image to a recording medium by a transfer device; and then removing, by a cleaning device, a toner remaining on the organic photoreceptor from the organic photoreceptor, wherein the protective layer is formed by polymerization of a polymerizable composition containing a polymerizable compound with a polymerizable functional group, and wherein the toner contains an antioxidant.

The image formation apparatus of the invention is featured in that it comprises an organic photoreceptor comprising a substrate and provided thereon, a photoreceptive layer and a protective layer in that order; a charging device for charging the organic photoreceptor; an exposure device for exposing a charged organic photoreceptor to form an electrostatic latent image on the organic photoreceptor; a developing device for developing the electrostatic latent image to form a toner image on the organic photoreceptor, the developing device comprising a developer containing a toner; a transfer device for transferring the toner image from the organic photoreceptor to a recording medium; and a cleaning device for removing a toner remaining on the organic photoreceptor from the organic photoreceptor, wherein the protective layer is formed by polymerization of a polymerizable composition containing a polymerizable compound having a polymerizable functional group, and wherein the toner contains an antioxidant.

### BRIEF EXPLANATION OF THE DRAWINGS

FIG. 1 is a schematic view of the image formation apparatus of the invention installed with image fog nation devices.

FIG. 2 is a cross-sectional view of a color image formation apparatus showing one embodiment of the invention.

FIG. 3 is a cross-sectional view of a color image formation apparatus showing another embodiment of the invention.

### DETAILED DESCRIPTION OF THE INVENTION

In order to solvent the problems described above, the present inventors have considered that it is necessary to inactivate an active gas such, as ozone or Nox which is accumulated on an organic photoreceptor surface, and to supply continuously an antioxidant onto the photoreceptor surface to maintain inactivation of the active gas. They have made an extensive study on continuous supply of an antioxidant onto the organic photoreceptor surface, and have completed the invention.

The present invention can be attained by any one of the following constitutions.

1. An image formation method comprising the steps of charging an organic photoreceptor by a charging device, the organic photoreceptor comprising a substrate and provided thereon, a photoreceptive layer and a protective layer in that order; imagewise exposing the charged organic photoreceptor by an exposure device to form an electrostatic latent image; developing the electrostatic latent image by a developing device to form a toner image, the developing device comprising a developer containing a toner; transferring the toner image to a recording medium by a transfer device; and then removing, by a cleaning device, a toner remaining on the organic photoreceptor from the organic photoreceptor, wherein the protective layer is formed by polymerization of a polymerizable composition containing a polymerizable compound with a polymerizable functional group, and wherein the toner contains an antioxidant.

2. The image formation method of item 1 above, wherein the antioxidant is added to the toner as a mixture.

3. The image formation method of item 1 above, wherein the antioxidant includes a hindered phenol compound.

4. The image formation method of item 2 above, wherein the antioxidant is added to the toner as a mixture in an amount of from 0.005 to 10 parts by mass based on 100 parts by mass of the toner before addition of the antioxidant.

5. The image formation method of item 1 above, wherein the polymerizable functional group of the polymerizable compound is selected from an unsaturated polymerizable functional group, a ring-opening polymerizable functional group or an isomerisation polymerizable functional group.

6. The image formation method of item 5 above, wherein the polymerizable functional group of the polymerizable compound is the unsaturated polymerizable functional group.

7. The image formation method of item 6 above, wherein the unsaturated polymerizable functional group is an acryloyl group (CH₂═CHCO—) or a methacryloyl group (CH₂CCH₃CO—).

8. The image formation method of item 1 above, wherein the polymerizable compound in the polymerizable composition includes a polymerizable compound with at least three of the polymerizable functional group.

9. The image formation method of item 8 above, wherein the content in the polymerizable composition of the polymerizable compound with at least three of the polymerizable functional group is 50% by mass or more of the total amount of the polymerizable compound used.

10. The image formation method of item 1 above, wherein the protective layer further contains metal oxide particles.

11. The image formation method of item 10 above, wherein the metal oxide particles are selected from titanium oxide particles, alumina particles, zinc oxide particles, and tin oxide particles.

12. The image formation method of item 10 above, wherein the metal oxide particles have a number average primary particle diameter of from 3 to 100 nm.

13. The image formation method of item 10 above, wherein the metal oxide particles are surface-processed with a surface-processing agent.

14. The image formation method of item 13 above, wherein the surface-processing agent includes a silane coupling agent or a titanium coupling agent.

15. The image formation method of item 13 above, wherein the surface-processing agent includes a chain polymerizable compound having a surface-processing group.

16. The image formation method of item 10 above, wherein the metal oxide particle content of the protective layer is from 10 to 200 parts by mass, based on 100 parts by mass of binder resin.

17. The image formation method of item 1 above, wherein the thickness of the protective layer is from 0.2 to 10 μm.

18. An image formation apparatus comprising an organic photoreceptor comprising a substrate and provided thereon, a photoreceptive layer and a protective layer in that order; a charging device for charging the organic photoreceptor; an exposure device for exposing a charged organic photoreceptor to form an electrostatic latent image on the organic photoreceptor; a developing device for developing the electrostatic latent image to form a toner image on the organic photoreceptor, the developing device comprising a developer containing a toner; a transfer device for transferring the toner image from the organic photoreceptor to a recording medium; and a cleaning device for removing a toner remaining on the organic photoreceptor from the organic photoreceptor, wherein the protective layer is formed by polymerization of a polymerizable composition containing a polymerizable compound having a polymerizable functional group, and wherein the toner contains an antioxidant.

The image formation apparatus of the invention, even when repeatedly operated under high temperature and high humidity conditions, not only prevents image blur from occurring but also improves a wear resistance property. That is, the image formation apparatus of the invention can achieve both high wear resistance property and high resistance to image blur.

The image formation method of the invention is featured in that it comprises charging an organic photoreceptor by a charging device, imagewise exposing the charged organic photoreceptor by an exposure device to form an electrostatic latent image, developing the electrostatic latent image by a developing device to form a toner image, transferring the toner image to a recording medium by a transfer device, and then removing, by a cleaning device, a toner remaining on the organic photoreceptor from the organic photoreceptor, the organic photoreceptor comprising a substrate and provided thereon, a photoreceptive layer and a protective layer in that order, and the developing device comprising a developer containing a toner, wherein the protective layer is formed by polymerization of a polymerizable composition containing a polymerizable compound with a polymerizable functional group, and wherein the toner contains an antioxidant.

The image formation method of the invention as described above, even when it is repeated under high temperature and high humidity conditions, not only prevents image blur from occurring but also improves a wear abrasion resistance property, which can achieve both high wear resistance property and high image blur resistance.

Next, the present invention will be explained in detail.

Firstly, the organic photoreceptor in the invention will be described.

The organic photoreceptor in the invention comprises a conductive substrate, and provided thereon, a photoreceptive layer and a protective layer in that order.

Production reaction of a polymer is divided largely into chain polymerization reaction and sequential polymerization reaction. The polymerizable compound in the invention refers to a polymerizable compound with a polymerizable functional group such as an unsaturated polymerizable functional group, a ring-opening polymerizable functional group or an isomerisation polymerizable functional group, which proceeds chain polymerization in the chain polymerization reaction, or a polymerizable compound with a hydroxyl group or a polymerizable compound with a hydrolysable group such as an organic silicon compound, each proceeding condensation reaction in the sequential polymerization reaction.

The protective layer in the invention will be described below.

The protective layer in the invention is formed by polymerization of a polymerizable compound, the polymerization providing a binder resin for the protective layer. The polymerizable compound in the invention is preferably a monomer for preparing a resin which is generally employed as a binder resin for an organic photoreceptor, for example, a monomer which is polymerized (cured) on exposure of actinic radiation such as ultraviolet ray or electron beam to form a resin such as polystyrene or polyacrylate, and is especially preferably a styrene monomer, an acryl monomer, a methacryl monomer, a vinyl toluene monomer, a vinyl acetate monomer, or an N-vinylpyrrolidone monomer.

The polymerizable functional group of the polymerizable compound is preferably an unsaturated polymerizable functional group. Among the polymerizable compounds, a polymerizable (curable) compound, which has an acryloyl group (CH₂═CHCO—) or a methacryloyl group (CH₂═CCH₃CO—) as the unsaturated polymerizable functional group, is especially preferred since the polymerization (curing) can be carried out in less exposure amount or in a short time.

In the invention, these polymerizable compounds may be employed singly or in combination.

As a cationically polymerizable compound, there are mentioned an epoxy compound, a vinyl ether compound and an oxetane compound. Among these, an oxetane compound is especially preferred.

Examples of the polymerizable compound will be listed. In the following examples, an Ac group number (an acryloyl group number) and a Mc group number (a methacryloyl group number) represent an acryloyl group number or a methacryloyl group number, respectively.

| Exemplified | | |
|---|---|---|
| Compound | | Ac Group |
| No. | Structural Formula | Number |
| Ac-1 | 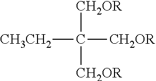 | 3 |
| Ac-2 | 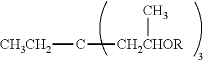 | 3 |
| Ac-3 | 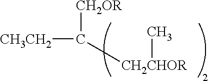 | 3 |
| Ac-4 | 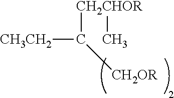 | 3 |
| Ac-5 | 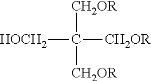 | 3 |
| Ac-6 | 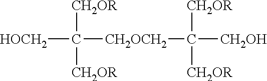 | 4 |
| Ac-7 | 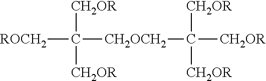 | 6 |
| Ac-8 | 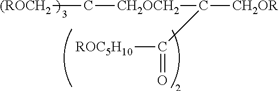 | 6 |
| Ac-9 | 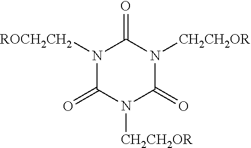 | 3 |
| Ac-10 | CH₃CH₂C— CH₂OC₃H₆OR)₃ | 3 |
| Ac-11 | 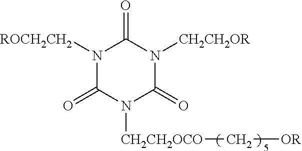 | 3 |
| Ac-12 | (ROCH₂_{₃}—C—O—C— CH₂OR)₃ | 6 |
| Ac-13 | 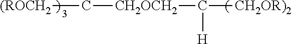 | 5 |
| Ac-14 | 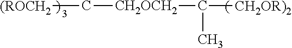 | 5 |
| Ac-15 | 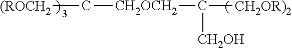 | 5 |
| Ac-16 | 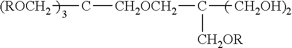 | 4 |
| Ac-17 | 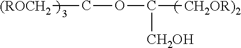 | 5 |
| Ac-18 | 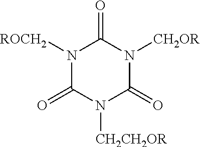 | 3 |
| Ac-19 | CH₃CH₂C— CH₂CH₂OR)₃ | 3 |
| Ac-20 | 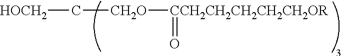 | 3 |
| Ac-21 | 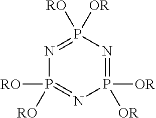 | 6 |
| Ac-22 | 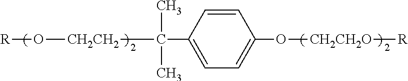 | 2 |
| Ac-23 | 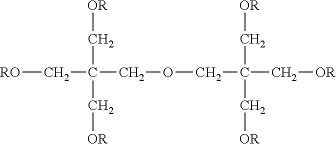 | 6 |
| Ac-24 | 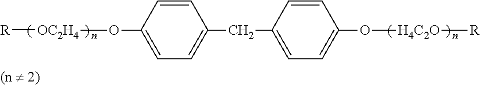 | 2 |
| Ac-25 | 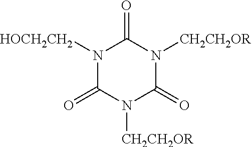 | 2 |
| Ac-26 | R— OC₃H₆_{₃}—OR | 2 |
| Ac-27 | 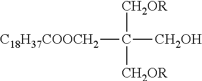 | 2 |
| Ac-28 | 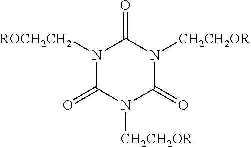 | 3 |
| Ac-29 | [R— OC₃H₆_{ₙ}—OCH₂_{₃}—CCH₂CH₃ | 3 |
| | (n ≠ 3) | |
| Ac-30 | 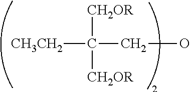 | 4 |
| Ac-31 | (ROCH₂_{₄}—C | 4 |
| Ac-32 | RO—C₆H₁₂—OR | 2 |
| Ac-33 | 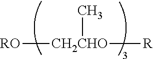 | 2 |
| Ac-34 | 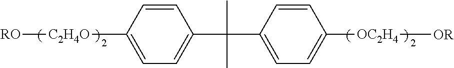 | 2 |
| Ac-35 | 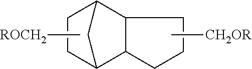 | 2 |
| Ac-36 | RO— C₂H₄O_{₉}—R | 2 |
| Ac-37 | 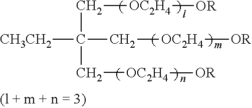 | 3 |
| Ac-38 | 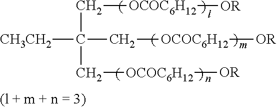 | 3 |
| Ac-39 | 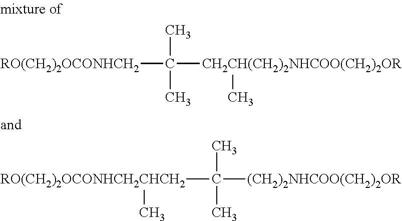 | 2 |
| Ac-40 | (ROCH₂)₃CCH₂OCONH(CH₂)₆NHCOOCH₂C(CH₂OR)₃ | 6 |
| Ac-41 | 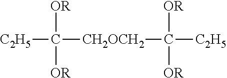 | 4 |

In the structural formulae above, R represents the following:

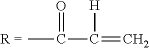

| Exemplified | | |
|---|---|---|
| Compound | | Mc Group |
| No. | Structural Formula | Number |
| Mc-1 | 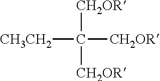 | 3 |
| Mc-2 | 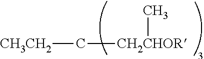 | 3 |
| Mc-3 | 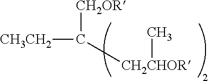 | 3 |
| Mc-4 | 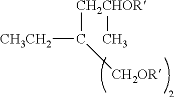 | 3 |
| Mc-5 | 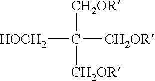 | 3 |
| Mc-6 | 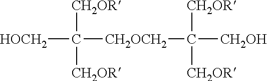 | 4 |
| Mc-7 | 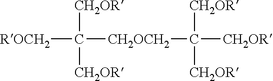 | 6 |
| Mc-8 | 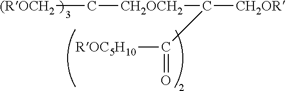 | 6 |
| Mc-9 | 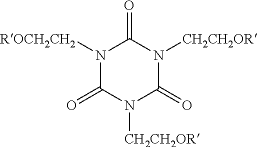 | 3 |
| Mc-10 | CH₃CH₂C— CH₂OC₃H₆OR′)₃ | 3 |
| Mc-11 | 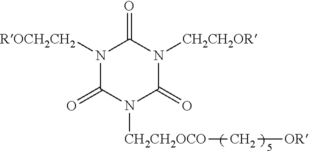 | 3 |
| Mc-12 | (R′OCH₂_{₃}—C—O—C— CH₂OR′)₃ | 6 |
| Mc-13 | 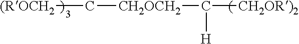 | 5 |
| Mc-14 | 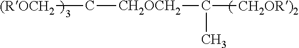 | 5 |
| Mc-15 | 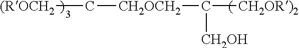 | 5 |
| Mc-16 | 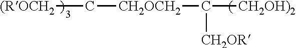 | 4 |
| Mc-17 | 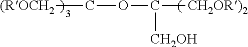 | 5 |
| Mc-18 | 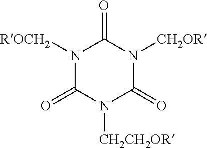 | 3 |
| Mc-19 | CH₃CH₂C— CH₂CH₂OR′)₃ | 3 |
| Mc-20 | 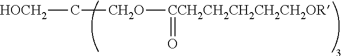 | 3 |
| Mc-21 | 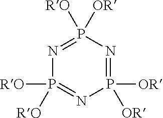 | 6 |
| Mc-22 | 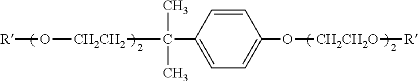 | 2 |
| Mc-23 | 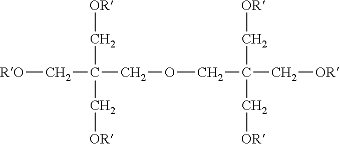 | 6 |
| Mc-24 | 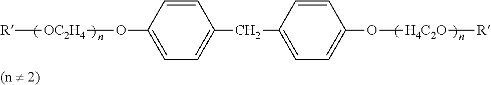 | 2 |
| Mc-25 | 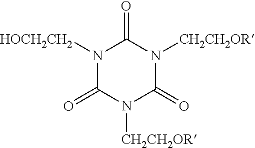 | 2 |
| Mc-26 | R′— OC₃H₆_{₃}—OR′ | 2 |
| Mc-27 | 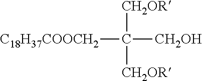 | 2 |
| Mc-28 | 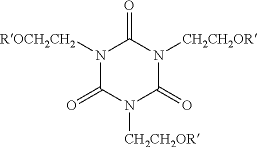 | 3 |
| Mc-29 | [R′— OC₃H₆_{ₙ}—OCH₂_{₃}—CCH₂CH₃ | 3 |
| | (n ≠ 3) | |
| Mc-30 | 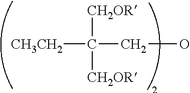 | 4 |
| Mc-31 | (R′OCH₂_{₄}—C | 4 |
| Mc-32 | R′O—C₆H₁₂—OR′ | 2 |
| Mc-33 | 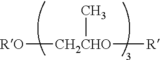 | 2 |
| Mc-34 | 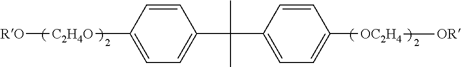 | 2 |
| Mc-35 | 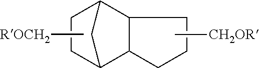 | 2 |
| Mc-36 | R′O— C₂H₄O_{₉}—R′ | 2 |
| Mc-37 | 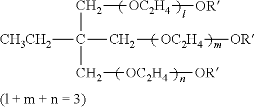 | 3 |
| Mc-38 | 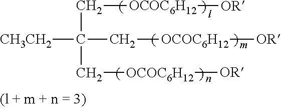 | 3 |
| Mc-39 | 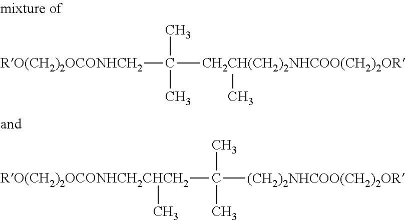 | 2 |
| Mc-40 | (R′OCH₂)₃CCH₂OCONH(CH₂)₆NHCOOCH₂C(CH₂OR′)₃ | 6 |
| Mc-41 | 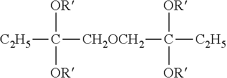 | 4 |

In the structural formulae above, R represents the following:

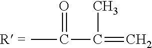

Next, preferred examples of the oxetane compound will be listed, but the invention is not specifically limited thereto.

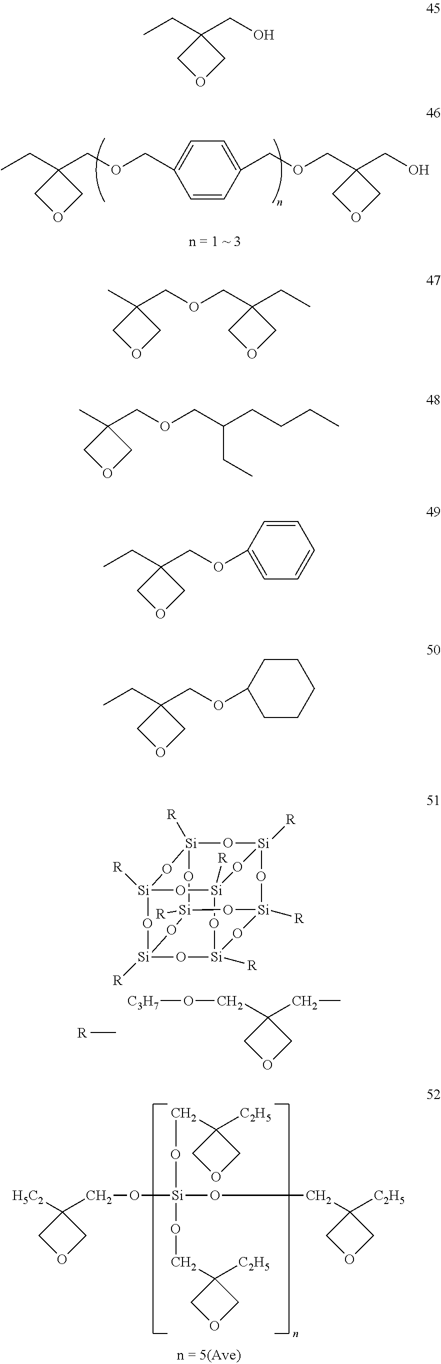

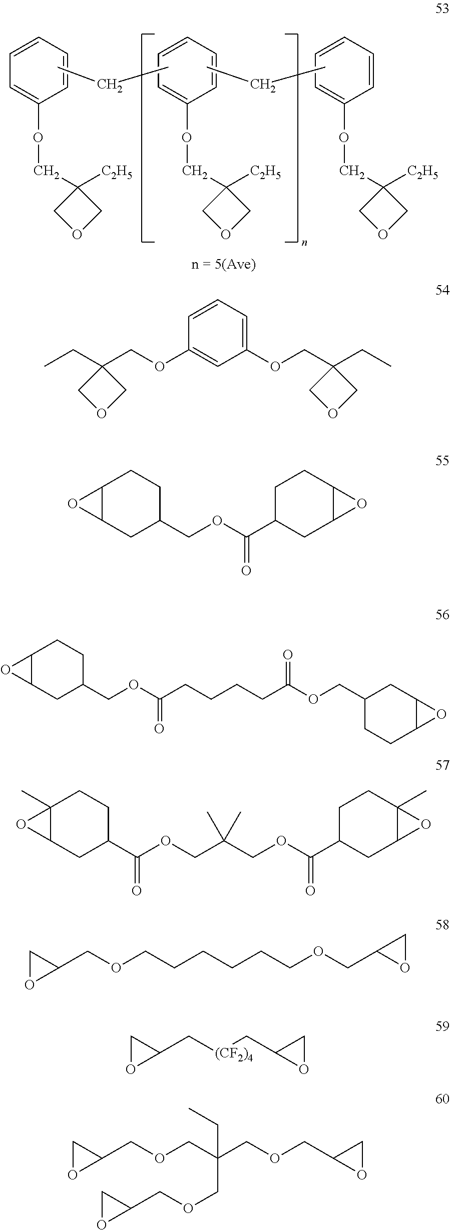

Examples of the epoxy compound include an aromatic epoxide, an alicyclic epoxide and an aliphatic epoxide.

In the invention, the polymerizable compound is preferably a polymerizable compound with at least three polymerizable functional groups (which mean reactive groups). The used amount of the polymerizable compound with at least three polymerizable functional groups is preferably 50% by mass or more of the total amount of polymerizable compound used.

Two or more kinds of the polymerizable compound can be employed in combination.

It is preferred that the protective layer in the invention contains inorganic particles. The inorganic particles are preferably those as described below.

### (Inorganic Particles)

The inorganic particles are preferably metal oxide particles including transition metal oxide particles. Examples of the inorganic particles include particles of metal oxides such as silica (silicon oxide), magnesium oxide, zinc oxide, lead oxide, aluminum oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium oxide, niobium oxide, molybdenum oxide, and vanadium oxide. Among these metal oxide particles, titanium oxide particles, alumina particles, zinc oxide particles and tin oxide particles are preferred.

The metal oxide particles are preferably those which are prepared according to a conventional production method such as a gas phase method, a chlorine method, a sulfuric acid method, a plasma method or an electrolysis method.

The number average primary particle diameter of the metal oxide particles above is preferably from 1 to 300 nm, and more preferably from 3 to 100 mm.

The number average primary particle diameter of the metal oxide particles is calculated according to the following method. A photograph of the particles is taken by a scanning electron microscope at 10000-fold magnification, and a photographic image of 300 particles (except for aggregated particles) randomly selected is read by a scanner. Subsequently, the number average primary particle diameter of the particles is calculated using an automatic image processing analysis apparatus LUZEX AP (product of Nireco Corporation) software version Ver. 1.32 from the photographic image.

The inorganic particles above are preferably subjected to surface processing with a surface-processing agent such as a silane coupling agent or a titanium coupling agent. Examples of the surface-processing agent include well known silane coupling agents such as t-butylphenyldichlorosilane, 3-methacryloxypropyldimethoxymethylsilane, 3-(3-cyanopropylthiopropyl)dimethoxymethylsilane, and hydrogen polysiloxane compounds and well known titanium coupling agents such as titanium methacrylate triisopropoxide, (2-methacroyloxyethoxy)triisopropoxytitanate, and titanium trimethacrylate methoxyethoxyethoxide.

Further, metal oxide particles surface-processed with a chain polymerizable compound having a surface-processing group are preferably employed.

The metal oxide particles surface-processed with a chain polymerizable compound can be prepared by reacting a chain polymerizable compound having a surface-processing group with metal oxide particles (in which generally, metal oxide particles not surface-processed have on the surface a hydroxyl group).

Examples of the chain polymerizable compound having a surface-processing group will be listed below.

### S-1 CH₂═CHSi(CH₃)(OCH₃)₂

### S-2 CH₂═CHSi(OCH₃)₃

### S-3 CH₂═CHSiCl₃

### S-4 CH₂═CHCOO(CH₂)₂Si(CH₃)(OCH₃)₂

### S-5 CH₂═CHCOO(CH₂)₂Si(OCH₃)₃

### S-6 CH₂═CHCOO(CH₂)₃Si(CH₃)(OCH₃)₂

### S-7 CH₂═CHCOO(CH₂)₃Si(OCH₃)₃

### S-8 CH₂═CHCOO(CH₂)₂Si(CH₃)Cl₂

### S-9 CH₂═CHCOO(CH₂)₂SiCl₃

### S-10 CH₂═CHCOO(CH₂)₃Si(CH₃)Cl₂

### S-11 CH₂═CHCOO(CH₂)₃SiCl₃

### S-12 CH₂═C(CH₃)COO(CH₂)₂Si(CH₃)(OCH₃)₂

### S-13 CH₂═C(CH₃)COO(CH₂)₂Si(OCH₃)₃

### S-14 CH₂═C(CH₃)COO(CH₂)₃Si(CH₃)(OCH₃)₂

### S-15 CH₂═C(CH₃)COO(CH₂)₃Si(OCH₃)₃

### S-16 CH₂═C(CH₃)COO(CH₂)₂Si(CH₃)Cl₂

### S-17 CH₂═C(CH₃)COO(CH₂)₂SiCl₃

### S-18 CH₂═C(CH₃)COO(CH₂)₃Si(CH₃)Cl₂

### S-19 CH₂═C(CH₃)COO(CH₂)₃SiCl₃

### S-20 CH₂═CHSi(C₂H₅)(OCH₃)₂

### S-21 CH₂═C(CH₃)Si(OCH₃)₃

### S-22 CH₂(CH₃)Si(OC₂H₅)₃

### S-23 CH₂═CHSi(OCH₃)₃

### S-24 CH₂(CH₃)Si(CH₃)(OCH₃)₂

### S-25 CH₂═CHSi(CH₃)Cl₂

### S-26 CH₂═CHCOOSi(OCH₃)₃

### S-27 CH₂═CHCOOSi(OC₂H₅)₃

### S-28 CH₂═C(CH₃)COOSi(OCH₃)₃

### S-29 CH₂═C(CH₃)COOSi(OC₂H₅)₃

### S-30 CH₂═C(CH₃)COO(CH₂)₃Si(OC₂H₅)₃

The silane coupling agents having a hole transporting group as described later can be employed as a surface-processing agent of the metal oxide particles.

HTM-1: 4-[2-(triethoxysilyl)ethyl]triphenylamine
HTM-2: 4-[2-(methyldiethoxysilyl)ethyl]triphenylamine
HTM-3: 4,4′,4″-tris[2-(triethoxysilyl)ethyl]triphenylamine
HTM-4: 4-[N,N-bis(3,4-dimethylphenyl)amino]-[2-(triethoxysilyl)ethyl]benzene
HTM-5: 4-[N,N-bis(3,4-dimethylphenyl)amino]-[2-(triethoxysilyl)propyl]benzene
HTM-6: 4-[3-(triethoxysilyl)propyl]triphenylamine
HTM-7: 4-[4-(triethoxysilyl)butyl]triphenylamine
HTM-8: 4-(N-ethyl-N-phenylamino)[2-(triethoxysilyl)ethyl]benzene

The synthetic method of the silane coupling agents above is described in Japanese Patent O.P.I. Publication No. 9-1900004 and the like.

The metal oxide particle content of the protective layer is preferably from 10 to 200 parts by mass, and more preferably from 20 to 150 parts by mass, based on 100 parts by mass of binder resin.

As a method of reacting the polymerizable compound in the invention, there is a reaction method employing ring opening via electron beams or a reaction method employing light or heat in the presence of a polymerization initiator such as a radical polymerization initiator or a cation polymerization initiator. As the polymerization initiator, a photopolymerization initiator or a thermal polymerization initiator can be employed as the polymerization initiator, and a photopolymerization initiator and a thermal polymerization initiator can be employed in combination.

The radical polymerization initiator for the polymerizable compound in the invention is preferably a photopolymerization initiator, and more preferably an alkylphenone compound or a phosphine oxide compound. A compound having an α-hydroxyacetophenone structure or an acylphosphine oxide structure is especially preferred. As the cation polymerization initiators, there are, for example, mentioned an ionic polymerization initiator such as an aromatic onium compound such as a salt of diazonium, ammonium, iodonium, sulfonium or phosphonium with B(C₆F₅)₄⁻, PF₆⁻, AsF₆⁻, SbF₆⁻ or CF₃SO₃⁻; or a nonionic polymerization initiator such as a sulfone compound generating a sulfonic acid, a halide compound generating a hydrogen halide or an iron-arene complex. A sulfone compound generating a sulfonic acid or a halide compound generating a hydrogen halide, which is a nonionic polymerization initiator, especially is preferred.

The photopolymerization initiator preferably used in the invention will be listed below.

### Examples of α-Aminoacetophenone Compounds

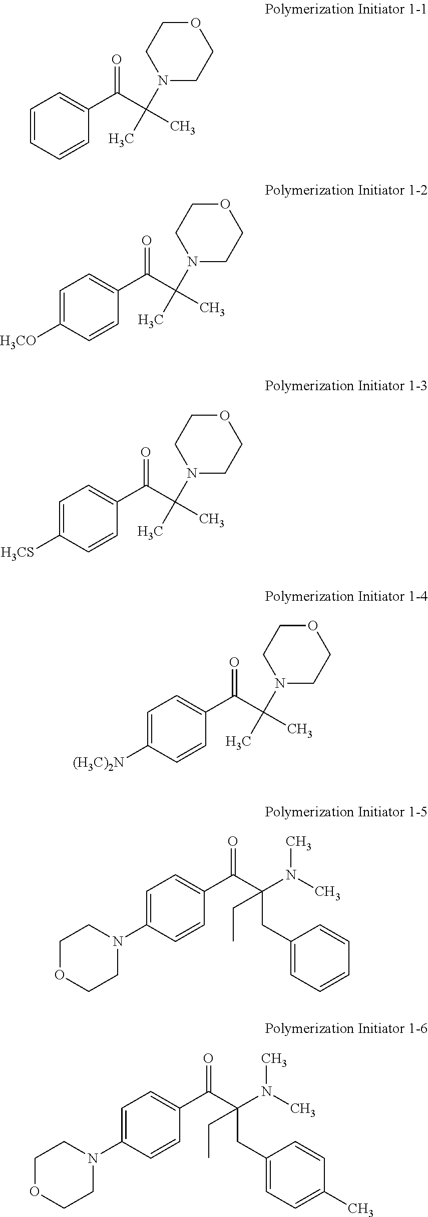

### Examples of α-Hydroxyacetophenone Compounds

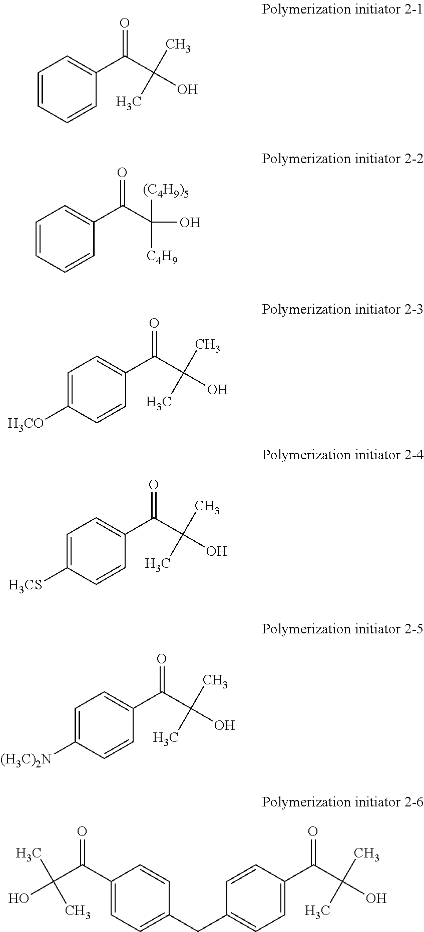

### Examples of Acylphosphine Oxide Compounds

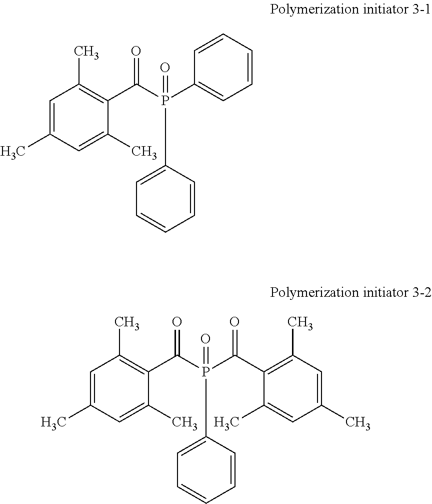

### Examples of Other Radical Polymerization Initiators

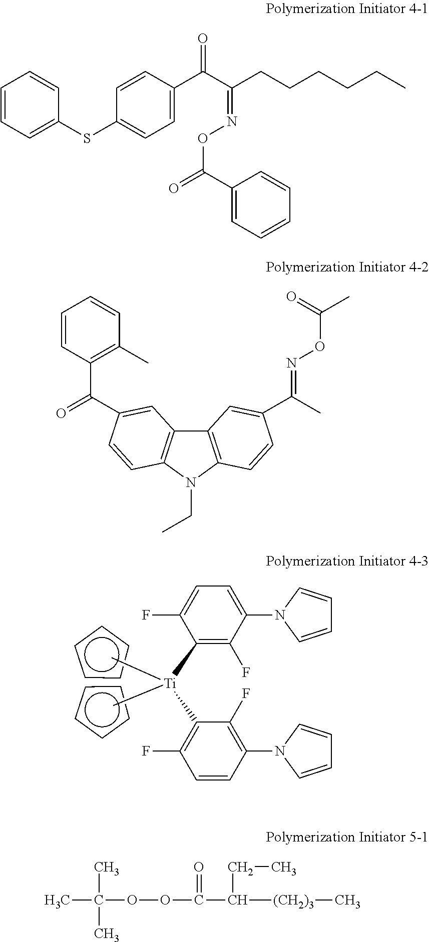

### Examples of Nonionic Polymerization Initiators

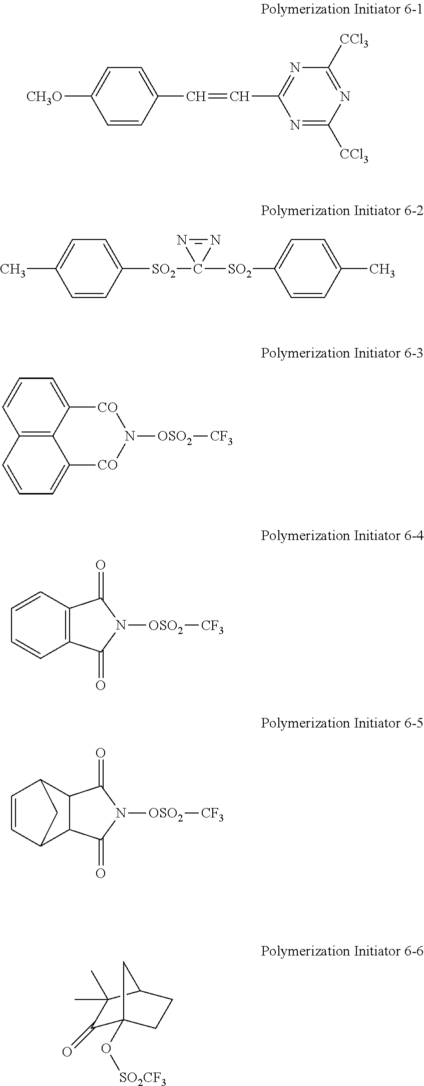

### Examples of Ionic Polymerization Initiators

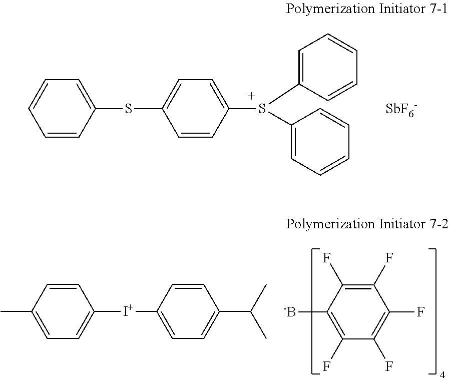

In order to form the protective layer in the invention, a method is preferred in which a protective layer coating solution (a composition containing a photopolymerization initiator, a polymerizable compound, surface-processed metal oxide particles and the like) is coated on a photoreceptive layer, subjected to primary drying to form a coated layer exhibiting no fluidity, exposed to ultraviolet ray the dried layer to form a cured protective layer, and then subjected to secondary drying to give a pre-determined amount of volatile substances in the cured protective layer.

As an ultraviolet ray exposure apparatus, a conventional apparatus used for curing an ultraviolet ray curable resin can be employed.

The amount (mJ/cm²) of ultraviolet ray exposure necessary to cure a resin is preferably controlled by ultraviolet ray irradiation intensity and irradiation duration.

As a thermal polymerization initiator, a ketone peroxide compound, a peroxyketal compound, a hydroperoxide compound, a dialkylperoxide compound, a diacylperoxide compound, a peroxydicarbonate compound or a peroxyester compound is employed, and these thermal polymerization initiators are disclosed in a manufacturer's product catalog and so forth.

In order to form the protective layer in the invention employing a thermal polymerization initiator, a method is preferred in which a protective layer coating solution containing a composition containing a thermal polymerization initiator, a polymerizable compound, surface-processed metal oxide particles and the like is coated on a photoreceptive layer in the same way as above, and then dried by heating to form a cured protective layer. As the thermal polymerization initiator, the radical polymerization initiators described above or other radical polymerization initiators can be employed.

Further, with regard to a coating method of the protective layer, an immersion coating method, in which the entire photoreceptive layer of the photoreceptor is immersed in the protective layer coating solution, causes diffusion of a polymerization initiator to an underlying layer. Therefore, to minimize dissolution of the photoreceptive layer under the protective layer as much as possible, it is preferred to use a coating method such as a circular amount regulation type (a typical example thereof is of a circular slide hopper type) coating method. The above circular amount regulation type coating method is detailed, for example, in Japanese Patent O.P.I. Publication No. 58-189061.

These polymerization initiators can be used alone or as an admixture of two or more kinds thereof. The content of the polymerization initiator is in the range of preferably from 0.1 to 20 parts by mass, and more preferably from 0.5 to 10 parts by mass, based on 100 parts by mass of acrylic compound.

The protective layer in the present invention can contain various kinds of charge transport materials, anti-oxidation agents or lubricant particles. For example, fluorine atom-containing resin particles can be added to the protective layer in the present invention. As the fluorine atom-containing resin, there are mentioned ethylene tetrafluoride resin, ethylene trifluoride chloride resin, ethylene propylene hexafluoride chloride resin, vinyl fluoride resin, vinylidene fluoride resin, and ethylene difluoride dichloride resin. It is preferred that one or more kinds of these resins are suitably selected and employed. The ethylene tetrafluoride resin and vinylidene fluoride resin are especially preferred. The content of the lubricant particles in the protective layer is in the range of preferably from 5 to 70 parts by mass, and more preferably from 10 to 60 parts by mass, based on 100 parts by mass of the binder resin. The average primary particle size of the lubricant particles is preferably from 0.01 to 1 and more preferably from 0.05 to 0.5 μm. The molecular weight of the resin can be suitably selected, and is not specifically limited.

Examples of a solvent for forming the protective layer include methanol, ethanol, n-propyl alcohol, isopropyl alcohol, n-butanol, t-butanol, sec-butanol, benzyl alcohol, toluene, xylene, methylene chloride, methyl ethyl ketone, cyclohexane, ethyl acetate, butyl acetate, methylcellosolve, ethylcellosolve, tetrahydrofuran, 1-dioxane, 1,3-dioxolane, pyridine, and diethyl amine, but the solvent is not specifically limited thereto.

It is preferred that the protective layer in the present invention is coated on a photoreceptive layer and then subjected to natural drying or heat drying, followed by actinic ray irradiation for reaction.

As a coating method of the protective layer in the invention, there can be employed a conventional method such as a dip coating method, a spray coating method, a spinner coating method, a bead coating method, a blade coating method, a beam coating method or a slide hopper coating method.

In the invention, it is preferred that the protective layer coating solution is coated on a photoreceptive layer, and irradiated with actinic radiation to produce radicals and proceed polymerization of the polymerizable compound to produce a cured resin (binder resin) with an intermolecularly and/or intramolecularly cross-linking bond, thereby forming a cured protective layer. As the actinic radiation, an ultraviolet ray and electron beam are especially preferred.

Any ultraviolet light source can be employed without any limitations, as long as it can emit an ultraviolet ray. Examples of the ultraviolet light source include a low pressure mercury lamp, an intermediate pressure mercury lamp, a high pressure mercury lamp, a super high pressure mercury lamp, a carbon arc lamp, a metal halide lamp, a xenon lamp, a flash or pulse xenon, and others. Irradiation conditions differ according to kinds of lamps. The irradiation amount of actinic ray is usually in the range of from 5 to 500 mJ/cm², and preferably in the range of from 5 to 100 mJ/cm². The electric power of the lamp is preferably in the range of from 0.1 kW to 5 kW, and more preferably in the range of 0.5 kW to 3 kW.

There is no special restriction to an electron beam irradiation apparatus as an electron beam source. Generally, a curtain beam type apparatus that provides high power at a relatively low cost is effectively used as an electron beam accelerator for emitting the electron beam. The acceleration voltage on electron beam irradiation is preferably in the range of from 100 to 300 kV. The absorption dose is preferably in the range of from 0.5 to 10 Mrad.

The irradiation time necessary to obtain the required irradiation amount of actinic ray is preferably from 0.1 sec to 10 min., and is more preferably from 0.1 sec to 5 min.

Ultraviolet ray, which is easy to use, is especially preferred as actinic ray.

The protective layer in the present invention can be dried before, after or during actinic ray irradiation. Appropriate timing for drying can be selected by a combination thereof.

The drying conditions can be selected according to the type of solvent and layer thickness. The drying temperature is preferably from room temperature to 180° C., and more preferably from 80° C. to 140° C. Drying time is preferably from Ito 200 minutes and more preferably from 5 to 100 minutes.

The thickness of the protective layer is in the range of preferably from 0.2 to 10 μm, and more preferably from 0.5 to 6 μm.

In the above, explanation is made of the protective layer formed by polymerization of a chain polymerization compound as a polymerizable compound, however, a protective layer, which is formed by a sequential reaction as described later, falls within the scope of the invention.

A protective layer of a polyurethane resin formed by reaction of a polyhydroxyl compound with a polyisocyanate compound also falls within the protective layer in the invention.

A protective layer of a siloxane resin formed by polycondensation reaction of a hydrolysable organosilicone compound also falls within the protective layer in the invention.

The constitution of an organic photoreceptor other than the protective layer will now be detailed.

In the invention, an organic photoreceptor means an electrophotographic photoreceptor composed of an organic compound having at least one function of charge generation function and charge transport function, which are essential to an electrophotographic photoreceptor. The organic photoreceptor in the invention includes well known organic photoreceptors such as those composed of a known organic charge generation material or organic charge transport material and those composed of a polymer complex having charge generation function or charge transport function.

The organic photoreceptor in the invention comprises a substrate (conductive), and provided thereon, a photoreceptive layer and the protective layer described above in that order. Typical examples of the layer constitution thereof will be shown below.

1) Layer constitution which comprises a conductive substrate, and provided thereon, an intermediate layer, a charge generation and charge transport layer as a photoreceptive layer and a protective layer in that order

2) Layer constitution which comprises a conductive substrate, and provided thereon, an intermediate layer, a single photoreceptive layer containing a charge generation material and a charge transport material, and a protective layer in that order

The layer constitution of the photoreceptor in the invention, which relates mainly to item 1) above, will be detailed below.

### [Substrate]

The substrate used in the invention may be any as long as it is conductive. Examples thereof include a drum or a sheet formed from a metal such as aluminum, copper, chromium, nickel, zinc or stainless steel; a plastic film laminated with a metal foil as an aluminum foil or a copper foil; a plastic film vapor deposited with aluminum, indium oxide or tin oxide; and a metal, plastic or paper sheet on which a conductive layer containing a conductive substance alone or in combination with a binder resin is coated.

### [Intermediate Layer]

In the invention, an intermediate layer having a bather function and an adhesion function can be provided between the conductive layer and the photoreceptive layer.

The intermediate layer is formed according to dip coating and the like. In the dip coating, a solution, in which a binder resin such as casein, polyvinyl alcohol, nitrocellulose, ethylene-acrylic acid copolymer, polyamide, polyurethane or gelatin is dissolved in a solvent, is employed. Of these, an alcohol soluble polyamide resin is preferred.

The intermediate layer can contain conductive microparticles or metal oxides for the purpose of adjusting the resistivity. For example, metal oxides such as alumina, zinc oxide, tin oxide, antimony oxide, indium oxide, and bismuth oxide or super microparticles such as tin doped indium oxide or antimony doped tin oxide or zirconium oxide can be employed.

These metal oxides may be employed singly or as an admixture of two or more kinds thereof. When two or more kinds of the metal oxides are mixed, the resulting mixture may be in the form of solid solution or in the fusion state. The average particle diameter of the metal oxides is preferably 0.3 μm or less, and more preferably 0.1 μm or less.

A solvent used for preparation of the intermediate layer is preferably one capable of effectively dispersing inorganic particles and dissolving a polyamide resin. Examples thereof include alcohols having a carbon atom number of from 2 to 4 such as ethanol, n-propyl alcohol, isopropyl alcohol, n-butanol, t-butanol, and sec-butanol which excel in polyamide resin dissolution or coating performances. Further, as an auxiliary solvent used in combination with the aforementioned solvent for improving the storage stability and particle dispersibility, there is mentioned methanol, benzyl alcohol, toluene, methylene chloride, cyclohexane or tetrahydrofuran.

The content of the binder resin in the intermediate layer is suitably selected considering the thickness or production speed of the intermediate layer.

When inorganic particles are dispersed in the binder resin, the amount of the inorganic particles is in the range of preferably from 20 to 400 parts by mass, and more preferably from 50 to 200 parts by mass, based on 100 parts by mass of the binder resin.

An ultrasonic homogenizer, a ball mill, a sand grinder or a homomixer can be used as a device for dispersing the inorganic particles, but the invention is not specifically limited thereto.

The method of drying the intermediate layer can be appropriately selected according to kinds of a solvent or the layer thickness. Thermal drying is preferred.

The thickness of the intermediate layer is preferably from 0.1 to 15 μm, and more preferably from 0.3 to 10 μm.

### [Charge Generation Layer]

The charge generation layer used in the invention contains a charge generation material and a binder resin, and is preferably one formed by coating of a dispersion solution in which the charge generation material is dispersed in a binder resin solution.

Examples of the charge generation material include an azo material such as Sudan Red or Diane Blue; a quinone pigment such as pyrene quinone or anthanthrone; a quinocyanine pigment; a perylene pigment; an indigo pigment such as indigo or thioindigo; and a phthalocyanine pigment, but are not limited thereto. These charge generation materials can be used singly or as a dispersion in which they are dispersed in the resin.

The conventional resin can be used as the binder resin of the charge generation layer. Examples of the binder resin include a polystyrene resin, a polyethylene resin, a polypropylene resin, an acryl resin, a methacryl resin, a vinyl chloride resin, a vinyl acetate resin, a polyvinyl butyral resin, an epoxy resin, a polyurethane resin, a phenol resin, a polyester resin, an alkyd resin, a polycarbonate resin, a silicone resin, a melamine resin, an copolymer resin containing two or more of these resins (e.g., vinyl chloride-vinyl acetate copolymer, vinyl chloride-vinyl acetate-maleic anhydride copolymer) and a polyvinyl carbazole resin, but the binder resin is not specifically limited thereto.

The charge generation layer is preferably one formed by the method comprising the steps of dispersing the charge generation material in a solution in which a binder resin is dissolved in a solvent, employing a homogenizer to prepare a coating solution; coating the coating solution on a substrate through a coating device so as to form a coated layer with a predetermined thickness; and drying the coated layer.

Examples of a solvent used for dissolving the binder resin used in the charge generation layer to prepare a coating solution include toluene, xylene, methylene chloride, 1,2-dichloroethane, methyl ethyl ketone, cyclohexane, ethyl acetate, butyl acetate, methanol, ethanol, propanol, butanol, methyl cellosolve, ethyl cellosolve, tetrahydrofuran, 1-dioxane, 1,3-dioxolane, pyridine and diethylamine, but the solvent is not specifically limited thereto.

An ultrasonic homogenizer, a ball mill, a sand grinder or a homomixer can be used as a device for dispersing the charge generation material, but the invention is not specifically limited thereto.

The amount of the charge generation material dispersed in the binder resin is preferably from 1 to 600 parts by mass, and more preferably from 50 to 500 parts by mass, based on 100 parts by mass of the binder resin. The thickness of the charge generation layer, although it differs due to the characteristics of the charge generation material or the characteristics or content of the binder resin, is preferably from 0.01 to 5 μm, and more preferably from 0.05 to 3 μm. The coating solution of the charge generation layer is filtered out to remove foreign matter or coagulants, thereby preventing occurrence of image defects. The charge generation layer can be also formed by vacuum deposition of the aforementioned pigments.

### [Charge Transport Layer]

The charge transport layer used in the photoreceptor in the invention contains a charge transport material (CTM) and a binder resin, and is formed by dispersing the charge transport material in a binder resin solution, and coating the resulting dispersion solution.

Examples of the charge transport material include carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl compounds, hydrazone compounds, pyrazoline compounds, oxazolone derivatives, benzimidazole derivatives, quinazoline derivatives, benzofuran derivatives, acridine derivatives, phenazine derivatives, aminostilbene derivatives, triarylamine derivatives, phenylene diamine derivatives, stilbene derivatives, benzidine derivatives, poly-N-vinyl carbazole, poly-1-vinyl pyrene, poly-9-vinyl anthracene, and triphenylamine derivatives. These materials can be used as an admixture of two or more kinds thereof.

The conventional resin can be used as the binder resin of the charge transport layer. Examples of the binder resin include a polycarbonate resin, a polyacrylate resin, a polyester resin, a polystyrene resin, a styrene-acrylonitrile copolymer resin, a polymethacrylate resin, and a styrene-methacrylate copolymer. Polycarbonate is preferred. Further, BPA, BPZ, dimethyl BPA, and BPA-dimethyl BPA copolymers are preferably used in view of excellent resistance to cracks, abrasion resistance property, or charge characteristics.

The charge transport layer is preferably one formed by the method comprising the steps of dissolving a binder resin and a charge transport material in a solvent to prepare a coating solution; coating the coating solution on a substrate through a coating device to form a coated layer with a predetermined thickness; and drying the coated layer.

Examples of the solvent for dissolving the binder resin and the charge transport material include toluene, xylene, methylene chloride, 1,2-dichloroethane, methyl ethyl ketone, cyclohexanone, ethyl acetate, butyl acetate, methanol, ethanol, propanol, butanol, tetrahydrofuran, 1,4-dioxane, 1,3-dioxolane, pyridine, and diethyl amine, but the solvent is not specifically limited thereto.

The amount of the charge transport material in the binder resin is preferably from 10 to 500 parts by mass, and more preferably from 20 to 100 parts by mass, based on 100 parts by mass of the binder resin.

The thickness of the charge transport layer, although it varies due to the characteristics of the charge transport material or the characteristics or content of the binder resin, and percentage of mixture, is preferably from 5 to 40 μm, and more preferably from 10 to 30 μm.

An antioxidant, an electron conductive agent or a stabilizer can be added to the charge transport layer. The antioxidants as disclosed in Japanese Patent O.P.I. Publication No. 2000-305291 and the electron conductive agents as disclosed in Japanese Patent O.P.I. Publication Nos. 50-137543 and 58-76483 are preferably used.

Next, the toner containing an antioxidant in the developing device in the invention will be explained.

The development device in the invention contains a developer containing a toner. A so-called toner for electrostatic image development is employed as the toner, and the toner in the invention contains toner particles and an antioxidant. The antioxidant is preferably contained in the toner as a mixture.

The toner in the invention contains an antioxidant. The antioxidant may be contained within the toner particles but is preferably added to the toner as a mixture. When the antioxidant is contained within the toner particles, the content in the toner of the antioxidant is preferably from 0.1 to 20 parts by mass, based on 100 parts by mass of toner particles. When the antioxidant is added to the toner as a mixture, the antioxidant is added to the toner in an amount of preferably from 0.005 to 10 parts by mass, and more preferably from 0.01 to 5 parts by mass, based on 100 parts by mass of the toner before addition of the antioxidant.

The reason it is preferred that the antioxidant is added to the toner as a mixture is presumed to be as follows.

The antioxidant as the mixture, which is separated from the toner and transferred onto the photoreceptor surface, inactivates an active gas such as ozone of Nox accumulated on the photoreceptor surface, whereby image blur resistance can be effectively improved.

Accordingly, it is required that such an antioxidant have adhesion property different from that of a conventional external additive for a toner, and that a more amount of an antioxidant remain on the photoreceptor surface after the toner is transferred onto the photoreceptor surface and further onto a recording medium to be removed from the photoreceptor surface, thereby increasing the above effects. Accordingly, it is desired that adhesion of the antioxidant to the toner particle surface be such that when development is conducted, the antioxidant is transferred onto the photoreceptor surface together with the toner particles, and when the toner transferred onto the photoreceptor surface is transferred on an intermediate transfer member or a recording medium, the antioxidant is separated from the toner and remains on the photoreceptor surface. An antioxidant contained inside toner particles reduces its transfer amount, however, a certain amount of an antioxidant is exposed on the toner particle surface, which exhibits a certain level of the effects.

### [Antioxidant]

An antioxidant restrains discoloration caused by light exposure as well as various oxidizing gases such as ozone, active oxygen, NOx and SOx. Examples of such an antioxidant include antioxidants described in Japanese Patent O.P.I. Publication Nos. 57-74192, 57-87989, and 60-72785; hydrazides described in Japanese Patent O.P.I. Publication No. 61-154989; hindered amine antioxidants described in Japanese Patent O.P.I. Publication No. 61-146591; nitrogen-containing heterocyclic mercapto compounds described in Japanese Patent O.P.I. Publication No. 61-177279; thioether antioxidants described in Japanese Patent O.P.I. Publication Nos. 1-115677 and 1-36479; hindered phenol antioxidants with a specific structure described in Japanese Patent O.P.I. Publication Nos. 1-36480 and 1-118137; ascorbic acids described in Japanese Patent O.P.I. Publication Nos. 7-195824 and 8-150773; zinc sulfate described in Japanese Patent O.P.I. Publication No. 7-149037; thiocyanates described in Japanese Patent O.P.I. Publication No. 7-314882; thiourea derivatives described in Japanese Patent O.P.I. Publication No. 7-314883; saccharides described in Japanese Patent O.P.I. Publication Nos. 7-276790 and 8-108617; phosphoric acid antioxidants described in Japanese Patent O.P.I. Publication No. 8-118791; nitrites, sulfites and thiosulfates described in Japanese Patent O.P.I. Publication 8-300807; and hydroxylamine derivatives described in Japanese Patent O.P.I. Publication No. 9-267544. Further, polycondensation products of dicyandiamide with polyalkylene polyamine, described in Japanese Patent O.P.I. Publication No. 2000-263928 can be suitably employed as the antioxidant.

The antioxidant used in the invention is preferably a hindered phenol compound.

Herein, the hindered phenol refers to a phenol compound or a phenol derivative having a branched alkyl group at the position ortho to the hydroxyl group, provided that the hydroxy group may be modified to an alkoxy group).

Next, typical examples of the antioxidant will be listed.

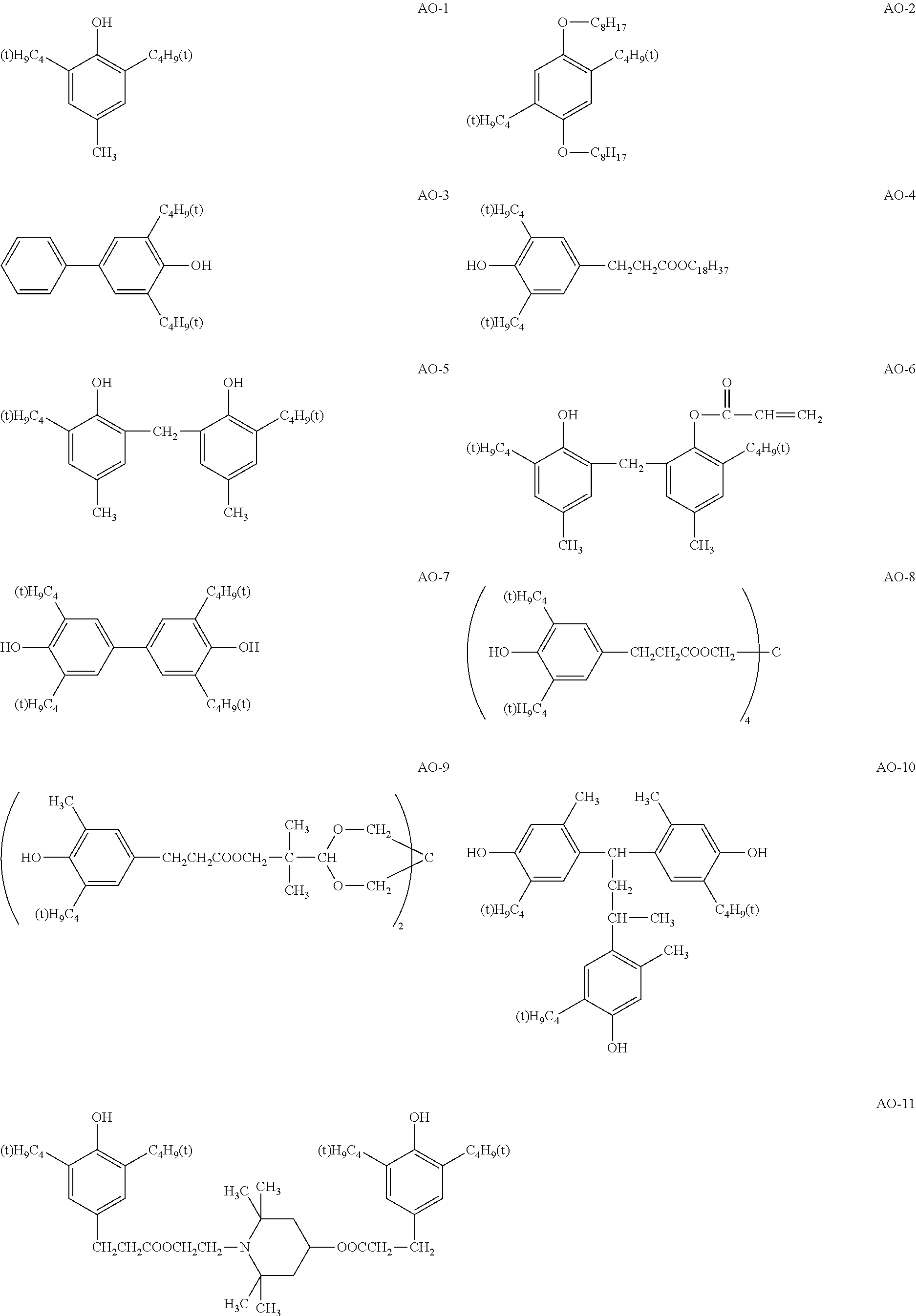

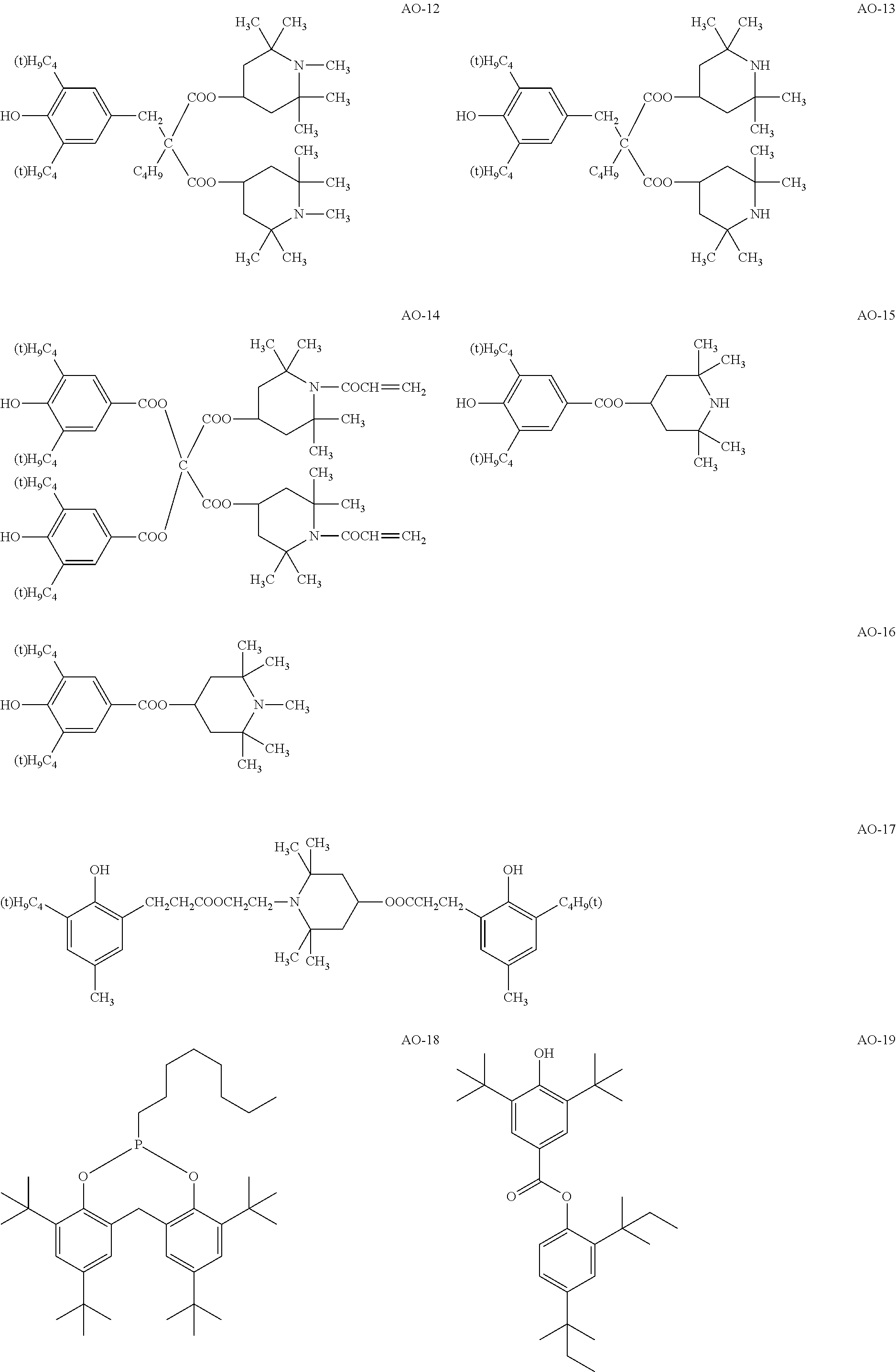

Examples of an antioxidant commercially available on the market include hindered phenol antioxidants such as IRGANOX 1076, IRGANOX 1010, IRGANOX 1098, IRGANOX 245, IRGANOX 1330, IRGANOX 3114, IRGANOX 1076 and 3,5-di-t-butyl-4-hydroxybiphenyl; hindered amine antioxidants such as SANOL LS2626, SANOL LS765, SANOL LS770, SANOL LS744, TINUVIN 144, TINUVIN 622LD, MARK LA57, MARK LA67, MARK LA62, MARK LA68, and MARK LA63; thioether antioxidants such as SUMILISER TPS and SUMILISER TP-D; and phosphite antioxidants such as MARK 2112, MARK PEP-8, MARK PEP-24G, MARK PEP-36, MARK 329K and MARK HP-10. Among these, the hindered phenol antioxidants are especially preferred.

In the invention, when an electrostatic latent image formed on the photoreceptor surface is developed with the toner in the invention, the antioxidant in the toner is supplied onto the entire surface of the photoreceptor, whereby performance deterioration of the photoreceptor due to oxidation is greatly suppressed.

Next, the components other than the antioxidant of the toner will be explained in detail.

The toner in the invention is generally called an electrostatic image developing toner, and is composed of toner particles, an external additive and so forth.

The toner particles above have a fundamental constitution in which pigments or dyes are dispersed in a binder resin for toner, but the toner particles may contain an anti-offset agent, a charge control agent and the like.

The toner may contain, as the external additive, a fluidizing agent, or a cleaning auxiliary.

The toner in the invention may be prepared by kneading and pulverizing the components, which are constituents in the toner particles, but may be prepared by a polymerization method (preparation of so-called polymerization toner). In the preparation of the polymerization toner, a surfactant, a polymerization initiator, a chain transfer agent and a coagulant are further employed during polymerization.

### [Toner Binder Resin]

As the toner binder resin, a thermoplastic resin exhibiting sufficient adhesion to colorant particles is preferably employed, and a solvent-soluble one is more preferably employed. A curable resin to form a three-dimensional structure can be also employed, as long as its precursor is solvent-soluble.

As such a toner binder resin, the resin which is commonly employed as the toner binder resin can be employed without any special limitations, and typical examples of such a toner binder resin include a styrene resin, an acrylic resin such as alkyl acrylate or alkyl methacrylate, a styrene-acrylic copolymer resin, a polyester resin, a silicone resin, an olefin resin, an amide resin and an epoxy resin. The styrene resin, acrylic resin and polyester resin exhibiting high transparency, low viscosity and high sharp-melt property are preferably employed in order to improve transparency and color reproduction of superimposed images. These can be employed singly or as an admixture of two or more kinds thereof.

When the toner particles constituting the toner in the invention are prepared according to a suspension polymerization method, an emulsion polymerization method or an emulsion polymerization coagulation method, examples of a polymerizable monomer used to obtain the toner binder resin include styrene monomers such as styrene, methylstyrene, methoxystyrene, butylstyrene, phenylstyrene and chlorostyrene; (meth)acrylic acid ester monomers such as methyl acrylate, ethyl acrylate, butyl acrylate, ethylhexyl acrylate, methyl methacrylate, ethyl methacrylate, butyl methacrylate and ethylhexyl methacrylate; and carboxylic acid monomers such as acrylic acid, fumaric acid and so forth.

A number average molecular weight (Mn) of the toner binder resin is preferably from 3,000 to 6,000 and more preferably from 3,500 to 5,500. The ratio of weight average molecular weight (Mw) to number average molecular weight (Mn), Mw/Mn is preferably from 2 to 6 and more preferably from 2.5 to 5.5. The glass transition point of the toner binder resin is preferably from 50 to 70° C., and more preferably from 55 to 70° C.; and the softening point is preferably from 90 to 110° C., and more preferably from 90 to 105° C.

### [Colorant]

As the colorant constituting the toner in the invention, there are mentioned an inorganic pigment, an organic pigment and a dye.

As the inorganic pigment, a conventional one can be employed. Typical examples of the inorganic pigment will be listed below.

As the black pigment, there are mentioned carbon black such as furnace black, channel black, acetylene black, thermal black and lamp black; and magnetic powder such as magnetite or ferrite.

These inorganic pigments can be employed singly or as an admixture of two or more kinds thereof. The addition amount of the pigment is preferably from 2 to 20% by mass, and more preferably from 3 to 15% by mass, based on the toner binder resin.

In a magnetic toner, the magnetite described above can be added to the toner and the magnetite content of the toner is preferably from 20 to 60% by mass to secure a specific magnetic property

As the organic pigment or the dye, a conventional one can be also employed. Typical examples of the organic pigment or the dye will be listed below.

Listed as magenta or red pigments are, for example, C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, Pigment Red 48:1, C.I. Pigment Red 53:1, C.I. Pigment Red 57:1, C.I. Pigment Red 112, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and, C.I. Pigment Red 222.

Listed as pigments for orange or yellow are, for example, C.I. Pigment Orange 31, C.I. Pigment Orange 43, C.I. Pigment Yellow 12, C.I. Pigment Yellow 13, C.I. Pigment Yellow 14, C.I. Pigment Yellow 15, Pigment Yellow 17, C.I. Pigment Yellow 93, C.I. Pigment Yellow 94, C.I. Pigment Yellow 138, C.I. Pigment Yellow 180, C.I. Pigment Yellow 185, C.I. Pigment Yellow 155 and C.I. Pigment Yellow 156.

Listed as pigments for green or cyan are, for example, C.I. Pigment Blue 15, C.I. Pigment Blue 15:2, C.I. Pigment Blue 15:3, C.I. Pigment Blue 16, C.I. Pigment Blue 60 and C.I. Pigment Green 7.

Listed as the dyes are, for example, C.I. Solvent Red 1, C.I. Solvent Red 49, C.I. Solvent Red 52, C.I. Solvent Red 58, C.I. Solvent Red 63, C.I. Solvent Red 111, C.I. Solvent Red 122, C.I. Solvent Yellow 19, C.I. Solvent Yellow 44, C.I. Solvent Yellow 77, C.I. Solvent Yellow 79, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, C.I. Solvent Yellow 162, C.I. Solvent Blue 25, C.I. Solvent Blue 36, C.I. Solvent Blue 60, C.I. Solvent Blue 70, C.I. Solvent Blue 93, and C.I. Solvent Blue 95, and a mixture thereof.

These organic pigments or dyes can be employed singly or as an admixture of two or more kinds thereof. The addition amount of the pigment is from 2 to 20% by mass, and preferably from 3 to 15% by mass, based on the mass of binder resin used.

The colorant can be surface-modified and employed. As a surface-modifying agent for modifying the colorant surface, a conventional one can be employed. Typically, a silane coupling agent, a titanium coupling agent or an aluminum coupling agent can be preferably employed as the surface-modifying agent

### [Offset Preventing Agent]

An offset preventing agent to contribute to prevention of offset phenomenon may be contained in toner particles constituting the toner in the present invention. Examples of the offset preventing agent include polyethylene wax, oxidizing polyethylene wax, polypropylene wax, oxidizing polypropylene wax, carnauba wax, sazole wax, rice wax, candellilla wax, jojoba oil wax and bees wax, but the invention is not limited thereto.

As methods to incorporate the offset preventing agent in toner particles, there are mentioned a method of salting out, aggregating and fusing toner binder resin particles, colorant particles and offset preventing agent particles by adding an offset preventing agent dispersion (wax emulsion) during the salt-out, aggregation and fusion processes in which toner particles are formed; and a method of salting out, aggregating and fusing toner binder resin particles containing the offset preventing agent and colorant particles during the salt-out, aggregation and fusion processes in which toner particles are formed. These methods may also be used in combination.

The content of an offset preventing agent in the toner particles is commonly 0.5 to 5 parts by mass, and preferably 1 to 3 parts by mass, based on 100 parts by mass of binder resin for toner particle formation. When the content of an offset preventing agent in the toner particles is less than 0.5 parts by mass, based on 100 parts by mass of binder resin for toner particle formation, sufficient offset prevention can not be achieved, while when the content of an offset preventing agent in toner particles exceeds 5 parts by mass, based on 100 parts by mass of binder resin for toner particle formation, the resulting toner provides lowered transparency and color reproduction.

### [Charge Control Agent]

A charge control agent may be contained in toner particles constituting toner in the invention. The charge control agent is not particularly limited, and as the charge control agent, there are mentioned various substances which give a positive or negative charge via friction-charging, for example, a colorless, white or hypochromatic charge control agent, which does not adversely affect color tone and transparency of the color toner, is mentioned as a negatively charging charge control agent usable for toner particles constituting color toner. Examples of such a charge control agent include a zinc or chromium metal complex of salicylic acid derivative (salicylic acid metal complex), a calixarene compound, an organic boron compound, a fluorine-containing quaternary ammonium salt compound and so forth. Specifically mentioned are the salicylic acid metal complexes disclosed in Japanese Patent O.P.I. Publication Nos. 53-127726 and 62-145255, the calixarene compounds disclosed in Japanese Patent O.P.I. Publication No. 2-201378, the organic boron compounds disclosed in Japanese Patent O.P.I. Publication No. 2-221967 and the fluorine-containing quaternary ammonium salt compounds disclosed in Japanese Patent O.P.I. Publication No. 3-1162.

The content of the charge control agent in the toner particles is ordinarily from 0.1 to 10 parts by mass, and preferably from 0.5 to 5 parts by mass, based on 100 parts by mass of binder resin for toner particle formation. The same method as described in a method to contain the foregoing offset preventing agent may be provided as a method to contain internal additives such as a charge control agent and the like in toner particles.

As a method to incorporate an internal additive such as a charge control agent and the like in toner particles, the same method as described above in the method to incorporate the offset preventing agent in the toner particles in the above may be conducted.

### [Chain Transfer Agent]

When toner particles constituting the toner in the invention are produced via an emulsion polymerization coagulation method, a conventional chain transfer agent can be utilized to adjust the molecular weight of the toner binder resin. The chain transfer agents are not specifically limited and include 2-chloroethanol, mercaptans such as octyl mercaptan, dodecyl mercaptan, t-dodecyl mercaptan, and styrene dimmers and so forth.

### [Polymerization Initiator]

When toner particles constituting the toner in the invention are produced via a suspension polymerization method, an emulsion polymerization method or an emulsion polymerization coagulation method, a polymerization initiator to obtain a toner binder resin can be appropriately employed as long as it is a water-soluble polymerization initiator. Examples of the polymerization initiator include persulfates such as potassium persulfate, ammonium persulfate and the like; azo compounds such as 4,4′-azobis-4-cyanovaleric acid and its salts, and 2,2′-azobis(2-amidinopropane) salts, and peroxide compounds.

### [Surfactant]

Various conventional ionic surfactants and nonionic surfactants can be employed as a surfactant used when toner particles constituting the toner in the invention are produced via a suspension polymerization method, an emulsion polymerization method, or an emulsion polymerization coagulation method.

### [Coagulant]

When toner particles constituting toner of the present invention are produced via an emulsion polymerization coagulation method, examples of usable coagulants include alkaline metal salts and alkaline earth metal salts. Examples of alkaline metal salts constituting the coagulant include lithium, potassium, sodium and so forth, and examples of alkaline earth metal salts constituting the coagulant include magnesium, calcium, strontium, barium and so forth. Of these, potassium, sodium, magnesium, calcium and barium are preferable. Examples of the counter ion (anion constituting a salt) of the foregoing alkaline metal or alkaline earth metal include a chloride ion, a bromine ion, an iodine ion, a carbonate ion and a sulfate ion.

### <Average Particle Diameter of Toner Particles>

The average particle diameter (in terms of volume based median particle diameter) of the toner particles used in the image formation method of the invention is preferably from 4 to 10 μm, and more preferably from 6 to 9 μm. For example, when the preparation of toner is carried out according to an emulsion polymerization coagulation method and the like, such an average toner particle diameter can be controlled via the concentration of a coagulant (a salting-out agent) used, an addition amount of an organic solvent, fusion time or the composition of a polymer to be obtained.

When the volume-based median particle diameter is in the above-described range, transfer efficiency is enhanced, whereby not only halftone image quality is improved, but also image quality of thin lines and dots are improved.

The volume based median particle diameter of the toner in the invention is determined and calculated employing a measuring device in which a data processing computer system (produced by Beckmann-Coulter Co.) is connected to “COULTER MULTISIZER TA-III”. For example, 0.02 g of clear toner is added to 20 ml of a surface active agent solution (a surface active agent solution which is prepared by diluting a neutral detergent containing surface active agent components with purified water by a factor of 10 for the purpose of dispersing the toner). After sufficient blending, ultrasonic dispersion is carried out over one minute to obtain a toner dispersion. The resulting toner dispersion is injected, employing a pipette, into a beaker on the sample stand, in which electrolyte “ISOTON II” (produced by Beckmann-Coulter Co.) is incorporated, until the displayed concentration of the measuring device reaches 5 to 10%. The above concentration provides reproducible measured values. The above measuring device is set at a measuring particle account number of 25,000 and an aperture diameter of 50 μm. The measurement diameter range of from 1 to 30 μm being divided into 256 diameters, frequency at each diameter was determined and the 50% volume cumulative diameter from the larger value is designated as the volume based median particle diameter.

### [External Additives]

The toner particles described above alone can constitute the toner in the invention. However, in order to improve fluidity, charging properties, cleaning properties and the like, the toner in the invention may be added with an external additive as a so-called post-processing agent such as a fluidizing agent or a cleaning aid.

As the post-processing agents, there are mentioned inorganic oxide particles such as silica particles, alumina particles and titanium oxide particles; inorganic stearic acid compound particles such as aluminum stearate particles and zinc stearate particles; and inorganic titanic acid compound particles such as strontium titanate particles and zinc titanate particles. These may be used alone or as an admixture of two or more kinds thereof.

These inorganic particles are preferably surface treated with a silane coupling agent, a titanium coupling agent, a higher fatty acid, or silicone oil in order to improve environmental stability or heat-resistant storage stability.

The content of these external additives in the toner is from 0.05 to 5 parts by mass, and preferably from 0.1 to 3 parts by mass, based on 100 parts by mass of toner. Further, the external additives may be employed as an admixture of two or more kinds thereof

### <Manufacturing Method of Toner>

As manufacturing methods of the toner used in the present invention, there are mentioned a kneading-pulverizing method, a suspension polymerization method, an emulsion polymerization method, an emulsion polymerization coagulation method, a mini-emulsion polymerization coagulation method, and an encapsulation method, as well as other known methods. The toner manufacturing method is preferably an emulsion polymerization coagulation method in view of production cost and production stability, considering that it is necessary to obtain toner particles with a small size in order to form a high quality image.

In the emulsion polymerization coagulation method, a dispersion of particles composed of a toner binder resin (hereinafter referred to as toner binder resin particles), which have been produced by an emulsion polymerization method, is mixed with a dispersion of other toner particle components such as colorant particles, and the mixture dispersion is subjected to slow aggregation, which is carried out while balancing the repulsive forces of particle surfaces due to pH control and aggregating forces generated due to addition of coagulants composed of electrolytes, wherein association is carried out while controlling the average particle diameter and the particle size distribution, and at the same time heating and stirring is carried out to cause fusion among particles and control the particle shape. Thus, toner particles are prepared.

As for the toner manufacturing method according to polymerization, a conventional manufacturing method as well as a method disclosed in Japanese Patent O.P.I. Publication No. 2000-214629 can be applied to the manufacturing method of the toner in the invention.

### [Developer]

The toner used in the invention may be employed as a magnetic or non-magnetic single component developer, but may also be employed as a double component developer after being blended with carriers. When the toner in the invention is employed as a double component developer, magnetic particles are usable as a carrier, which are composed of the materials known in the art such as a metal of iron, ferrite or magnetite, as well as an alloy of the above metal with aluminum or lead. Of these, ferrite particles are especially preferred. Further, employed as a carrier may be a coated carrier prepared by coating the surface of magnetic particles with a covering agent such as a resin, and a binder type carrier prepared by dispersing magnetic powder in a binder resin.

The covering resin constituting the coated carrier is not particularly limited, and examples thereof include olefin resins, styrene resins, styrene-acryl resins, silicone resins, polyesters and fluorine-containing resins. Further, a resin constituting a resin dispersion type carrier is not particularly limited, and conventional ones can be used. Examples thereof include an olefin resin, a styrene resin, a styrene-acryl resin, an ester resin, a fluorine-containing resin and a phenol resin.

The volume based median diameter of the carrier is preferably from 20 to 100 μm, and more preferably from 20 to 60 μm. The volume based median diameter of the carrier is determined, employing a laser diffraction type particle size distribution meter “HELOS” (produced by SYMPATEC Co.) as a representative meter.

Of these carriers, a resin-coated carrier, in which a silicone resin, a copolymer resin (graft resin) of organopolysiloxane and a vinyl monomer or a polyester resin is used as a resin for coating, is preferred from the viewpoint of spent resistance. A carrier coated with a resin, which is obtained by reacting isocyanate with a copolymer resin of organopolysiloxane and a vinyl monomer, is especially preferred in terms of durability, environmental stability and spent resistance.

Next, an image formation apparatus in the invention will be explained.

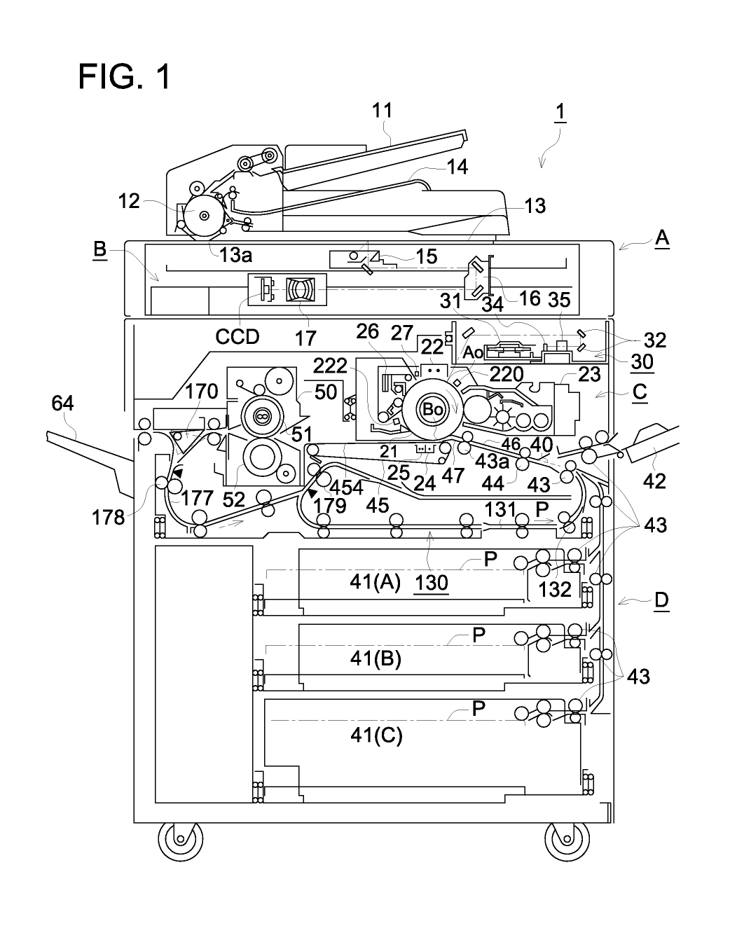

The image formation apparatus 1 shown in FIG. 1 is a digital type image formation apparatus, and is composed of an image reading section A, an image processing section B, an image formation section C, and a recording sheet conveyance section D for conveying a recording sheet.

An automatic document feeding unit to automatically convey documents is provided on the upper portion of the image reading section A, and documents placed on a document placement board 11 are separated one by one sheet and conveyed by a document conveyance roller 12, and an image is read at a reading position 13a. The document, after the image has been read, is delivered by the document conveyance roller 12 onto a document sheet delivery tray 14.

When a document is placed on a platen glass 13, an image of the document is read out by reading operation at a speed of v of a first mirror unit 15 which is composed of an illumination lamp and a first mirror, and by movement in the same direction at a speed of v/2 of a second mirror unit 16 which is composed of a second mirror and a third mirror, which are positioned in V-letter shape, wherein the first minor unit 15 and the second mirror unit constitute a scanning optical system.

The read image is formed on the light receiving surface of an image pick-up element CCD, which is a line sensor, through a projection lens 17. Line-shaped optical images formed on the image pick-up element CCD are successively converted photoelectrically into electrical signal (brightness signal), then A/D converted, and subjected to density conversion processing, filter processing and the like in an image processing section B, whereby the image data is temporarily stored in a memory.

In the image formation section C, there are provided an image carrier, a photoreceptor 21 in the form of drum and arranged around the outer periphery of the photoreceptor, an image formation unit including a charging device (charging step) 22 to charge the photoreceptor 21, a potential detecting device 220 to detect the potential on the charged photoreceptor, a developing device (developing step) 23, a transfer belt device 45 as a transfer device (transfer step), a cleaning device 26 for cleaning the photoreceptor 21 (cleaning step), and a PCL (pre-charge lamp) 27 as a photo potential eliminating device (photo potential eliminating step) in that order of operation. A reflection density meter 222, which measures reflection density of developed patch image on the photoreceptor 21, is provided downstream of the developing device 23. The photoreceptor 21, employing the organic photoreceptor in the invention, is rotated clockwise in the drawing.

The photoreceptor 21 which rotates is subjected to uniform charging through the charging device 22, and then to image exposure through an image exposure optical system as an image exposure device 30 based on an image signal read from the memory of the image processing section B. The image exposure optical system as the image exposure device 30, which is a writing device, uses a laser diode (not illustrated) as a light emitting source, and changes an optical path by a reflection mirror 32 through a rotating polygonal mirror 31, a fθ lens 34 and a cylindrical lens 35, whereby primary scanning is conducted. The image exposure is conducted at the position Ao of the photoreceptor 21, and an electrostatic latent image is formed by the rotation (subsidiary scanning) of the photoreceptor 21. In the present embodiment, exposure is conducted at a portion having characters to form an electrostatic latent image.

In the image formation apparatus of the invention, a semiconductor laser or a luminance emission diode each having an oscillation wavelength of from 350 to 500 nm is employed as an image exposure source to form an electrostatic latent image on the photoreceptor.

The organic photoreceptor is digitally exposed employing the image exposure source, the light beam spot diameter of exposure light in the primary scanning direction for writing being reduced to 10-50 μm, whereby an electrophotographic image with a high definition of from 600 to 2500 dpi (dpi: a dot number per 2.54 cm) can be obtained

The light beam spot diameter is a length of the exposure light beam spot (Ld measured at the maximum position) in the primary scanning direction in an area having exposing intensity of not less than 1/e² times of peak intensity of the exposure light beam.

As an image exposure source used, there are one of a scanning optical system employing a semiconductor laser, and one of a solid scanner such as LED, and as a light intensity distribution, there are a Gaussian distribution, a Lorentzian distribution and so on. The area having a light intensity of not less than 1/e² times of peak intensity in the light intensity distribution is defined as the light beam spot in the invention.

The electrostatic latent image on the photoreceptor 21 is reversal-developed by the developing device 23 to form a visual toner image on the surface of the photoreceptor 21. In the image formation method of the invention, a developer comprising a toner containing an anti-oxidant is used in the developing device.

In the recording sheet conveyance section D, sheet feed units 41(A), 41(B) and 41(C) in which recording sheets P with a different size are accommodated, are provided in the lower portion of the image formation unit, and a manual sheet feed unit 42 to conduct manual sheet feed is provided on the side portion of the image formation unit, where the recording sheet P selected from any one of these sheet feed units, is fed along a sheet conveyance path 40 by a guiding roller 43. The recording sheet P is temporarily stopped, then re-fed, and guided to the sheet conveyance path 40, a pre-transfer roller 43a, a sheet feed path 46 and an entrance guide plate 47 through a pair of sheet feed register rollers 44 by which inclination and deflection of the transfer sheet to be fed are corrected. Then, the toner image on the photoreceptor drum 21 is transferred onto the recording sheet P at a transfer position Bo by a transfer electrode 24 and a separation electrode 25. Then, the recording sheet P with a transferred image is separated from the photoreceptor 21, provided on a transfer conveying belt 454 of a transfer conveying belt device 45 and conveyed to the fixing device 50 by the transfer conveying belt device 45.

The fixing device 50 has a fixing roller 51 and a pressure roller 52, and the recording sheet P passes between the fixing roller 51 and the pressure roller 52, whereby heat and pressure are applied to fix the toner image. The recording sheet P with the fixed toner image is delivered onto the sheet delivery tray 64.

A procedure forming an image on one side of the recording sheet is described above. When the copies are made on both sides of the recording sheet, the sheet feed path changing device 170 is switched so that the recording sheet guiding section 177 is opened and the recording sheet P is conveyed in the direction of an arrow as shown in a broken line.

The recording sheet P is conveyed to the lower direction through a conveying mechanism 178 and switch-backed through a recording sheet reverse section 179, so that the tail of the paper is reversed to the top, and guided into a sheet feed device 130 for double-surface copying.

The recording sheet P is conveyed in the sheet feed direction on a conveying guide 131 provided in the sheet feed device 130 for double-surface copying, re-fed by a sheet feed roller 132, and guided to the sheet conveyance path 40.

As described above, the recording sheet P is conveyed to the photoreceptor 21, and a toner image is transferred onto the back side of the recording sheet P, fixed through the fixing device 50 and delivered onto the sheet delivery tray 64.

In the image formation apparatus according to the invention, the photoreceptor and another device such as the developing device or the cleaning device may be combined to form one unit as a processing cartridge. The processing cartridge can be detachably installed to the main body of the apparatus. Further, at least one of a charging device, an imagewise exposure device, a developing device, a transfer or separation device and a cleaning device may be unitized with the photoreceptor to form a processing cartridge which is detachably installed to the main body of the apparatus, the processing cartridge being capable of being installed to or removed from the main body using a guiding device such as a rail.

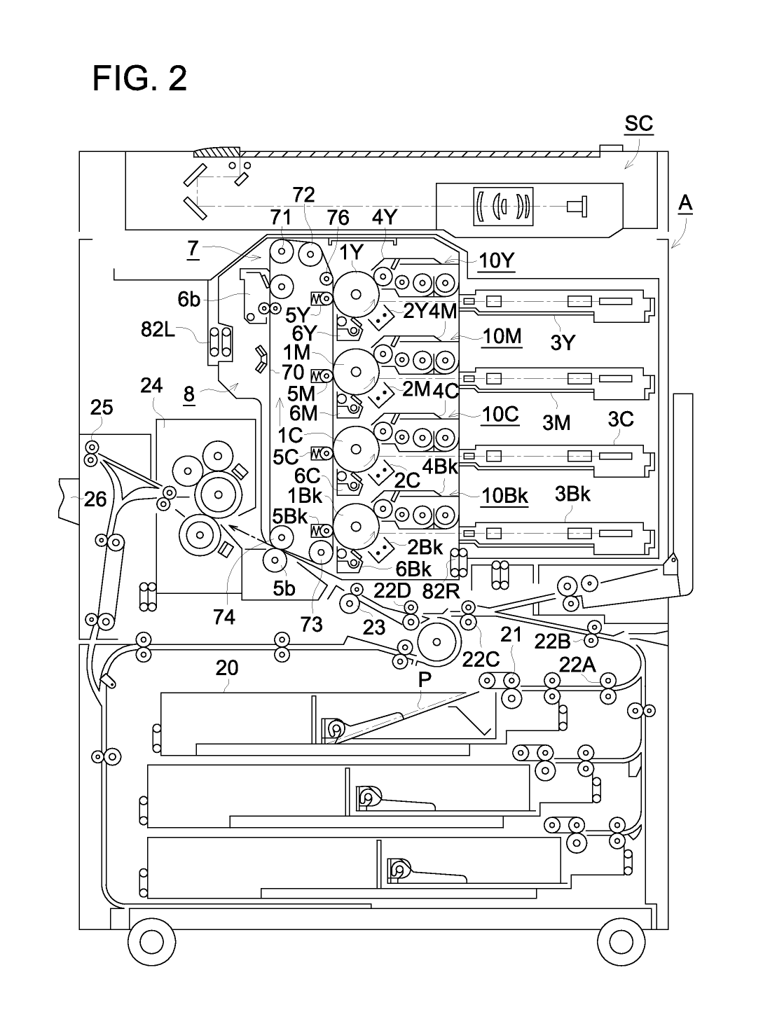

FIG. 2 is a sectional view of a color image formation apparatus showing one embodiment of the invention.

This image formation apparatus is called a tandem color image formation apparatus, which is composed of four image formation sections (hereinafter also referred to as image formation units) 10Y, 10M, 10C and 10Bk, an endless belt intermediate transfer unit 7, a paper sheet conveying device 21, and a fixing device 24. A reading device SC for reading a document is disposed at the upper portion of the image formation apparatus main body A.

Image formation section 10Y to form a yellow image comprises a drum-shaped photoreceptor 1Y as a first image carrying member, and disposed at the circumference of the photoreceptor 1Y, a charging device (charging step) 2Y, an exposure device (exposing step) 3Y, a developing device (developing step) 4Y, a primary transfer roller 5Y as a primary transfer device (primary transfer step) and a cleaning device (cleaning step) 6Y. Image formation section 10M to form a magenta image comprises a drum-shaped photoreceptor 1M as a first image carrying member, a charging device 2M, an exposure device 3M, a developing device 4M, a primary transfer roller 5M as a primary transfer device and a cleaning device 6M. Image formation section 10C to form a magenta image comprises a drum-shaped photoreceptor 1C as a first image carrying member, a charging device 2C, an exposure device 3C, a developing device 4C, a primary transfer roller 5C as a primary transfer device and a cleaning device 6C. Image formation section 10Bk to form a black image comprises a drum-shaped photoreceptor 1Bk as a first image carrying member, a charging device 2Bk, an exposure device 3Bk, a developing device 413k, a primary transfer roller 5Bk as a primary transfer device and a cleaning device 6Bk.

The aforementioned four image formation sections 10Y, 10M, 10C and 10Bk respectively comprises photoreceptor drums 1Y, 1M, 1C and 1Bk, and disposed at the circumference of the photoreceptor drums, rotary charging devices 2Y, 2M, 2C and 2Bk, exposure devices 3Y, 3M, 3C and 3Bk, rotary developing devices 4Y, 4M, 4C and 4Bk, and cleaning devices 6Y, 6M, 6C and 6Bk for cleaning the photoreceptor drums 1Y, 1M, 1C and 1Bk.

The image formation sections 10Y, 10M, 10C and 10Bk have the same structure, except that colors of toner images formed on each of the photoreceptor drums 1Y, 1M, 1C and 1Bk are different. Next, explanation will be made in detail employing the image formation unit 10Y as an example.

The image formation unit 10Y comprises a photoreceptor drum 1Y, which is an image formation member, and disposed at the circumference of the photoreceptor drum, a charging device 2Y (hereinafter also referred to simply as charging device 2Y or charger 2Y), an exposure device 3Y, a developing device 4Y, and a cleaning device 6Y (hereinafter also referred to simply as cleaning device 6Y or cleaning blade 6Y), and forms a yellow toner image on the photoreceptor drum 1Y. In the embodiment of the invention, at least the photoreceptor drum 1Y, the exposure device 2Y, the developing device 4Y and the cleaning device 5Y in the image formation unit 10Y are integrated.

The charging device 2Y is one providing a uniform electric potential on the photoreceptor drum 1Y. In the embodiment of the invention, a corona discharge type charger 2Y is used for the photoreceptor drum 1Y.

The exposure device 3Y is one which exposes the photoreceptor drum 1Y given a uniform electric potential by the charger 2Y based on image signal (yellow) to form a latent image corresponding to a yellow image. As the exposure device 3Y, there is a device constituted of an imaging element (trade name: SELFOC lens) and an LED in which light-emitting elements are arranged in an array configuration in the axial direction of photoreceptor drum 1Y or a semiconductor laser optical system.

In the image formation apparatus according to the invention, the photoreceptor described above and another device such as the developing device or the cleaning device may be combined to form one unit as a processing cartridge (an image formation unit). The processing cartridge can be detachably installed to the main body of the apparatus. Further, at least one of a charging device, an imagewise exposure device, a developing device, a transfer or separation device and a cleaning device may be unitized with the photoreceptor to form a processing cartridge (an image formation unit) which is detachably installed to the main body of the apparatus, the processing cartridge being capable of being installed to or removed from the main body using a guiding device such as a rail.

An endless belt intermediate transfer member unit 7, which is turned by plural rollers, comprises an endless belt intermediate transfer device 70 as a second image carrying member in the endless belt form, which is pivotably supported.

The individual color images formed by the image formation units 10Y, 10M, 10C and 10Bk are successively transferred onto the rotating endless belt intermediate transfer device 70 by primary transfer devices, primary transfer rollers 5Y, 5M, 5C and 5Bk, respectively, to form a composite color image. The recording sheet P as an image receiving sheet (a support such as a plain paper sheet or a transparent sheet on which a final fixed image is to be formed) housed in a paper feed cassette 20 is fed by a paper feed device 21 and conveyed to a secondary transfer device, a secondary transfer roller 5b through plural intermediate rollers 22A, 22B, 22C and 22D and a resist roller 23, where color images are transferred together on the recording sheet P. The recording sheet P with the transferred color images is fixed by a fixing device 24, nipped by a paper discharge roller 25, and put onto a paper discharge tray 26 disposed outside the apparatus. Herein, an image receiving support such as the intermediate transfer device and the recording sheet, onto which toner images formed on a photoreceptor are transferred, is collectively referred to as an image receiving medium.

After a color image is transferred onto the recording sheet P by a secondary transfer roller 5b as a secondary transfer device, any residual toner which remains on the endless belt intermediate transfer device 70 from which the recording sheet P is separated is removed by a cleaning device 6b.

During image formation, the primary transfer roller 5Bk is always in contact with the photoreceptor 1Bk. Other primary transfer rollers 5Y, 5M and 5C are brought into contact with the photoreceptors 1Y, 1M and 1C, respectively, only at the time when color images are formed on the photoreceptors 1Y, 1M and 1C.

The secondary transfer roller 5b is brought into contact with the endless belt intermediate transfer device 70 only when secondary transfer onto the recording sheet P is carried out.

The housing 8 is disposed in the image formation apparatus body A so that it can be pulled out from the image formation apparatus body A through supporting rails 82L and 82R.

The housing 8 is composed of image formation sections 10Y, 10M, 10C and 10Bk, and an endless belt intermediate transfer unit 7.

Image formation sections 10Y, 10M, 10C, and 10Bk are arranged in column in the vertical direction. The endless belt intermediate transfer unit 7 is disposed on the left side in the figure of the photoreceptor drums 1Y, 1M, 1C, and 1Bk. The endless belt intermediate transfer unit 7 is composed of an endless belt intermediate transfer device 70 capable of rotating, which can rotate rollers 71, 72, 73, 74 and 76, primary image transfer rollers 5Y, 5M, 5C, and 5Bk, and the cleaning device 6b.

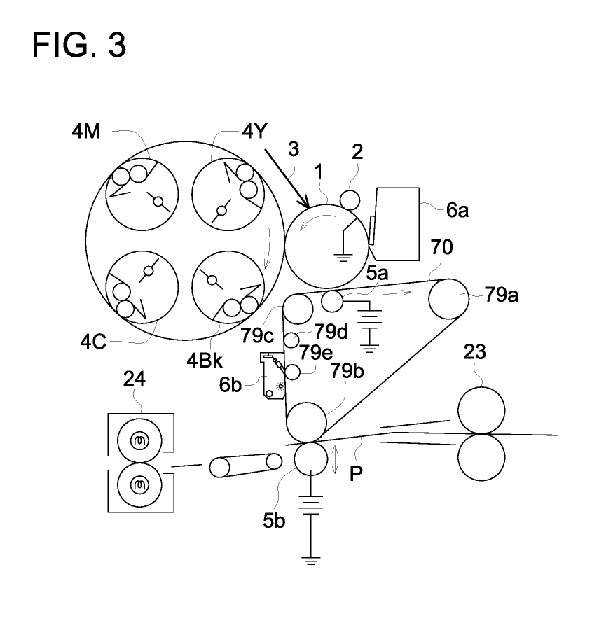

FIG. 3 is a cross-sectional view of another embodiment of the color image formation apparatus of the invention (a copier or a laser beam printer comprising an organic photoreceptor and provided around the photoreceptor, at least a charging device, an exposure device, a plurality of developing devices, a transfer device, a cleaning device, and an intermediate transfer device). An elastic material with a medium resistance is used in an intermediate transfer device 70 in the form of a belt.

Numeral 1 shows a drum-type photoreceptor which is repeatedly used as an image formation device and rotationally driven at a predetermined peripheral rate in the counter-clockwise direction as shown in an arrow.

Photoreceptor 1 is uniformly charged during rotation at a given polarity and potential through a charging device 2 (charging step), and then is subjected to image exposure such as scanning exposure using laser beams modulated in accordance with chronological electric digital pixel signals of image information through an image exposure device 3 (image exposure step) not illustrated, thereby forming on the photoreceptor an electrostatic latent image corresponding to a color component image (color information) of yellow (Y) of the targeted color image.

Subsequently, the resulting electrostatic latent image is developed with a first color toner, a yellow toner, employing a first developing device (a yellow developing device) 4Y, whereby a yellow toner image is formed on the photoreceptor 1 as a first color toner image. During the above development, any of a second developing device (a magenta developing device 4M), a third developing device (a cyan developing device 4C) and a fourth developing device (a black developing 4Bk) is switched off and does not act on the photoreceptor 1, and therefore, the yellow toner image as the first color toner image above is not affected by the second, third and fourth developing devices.

Intermediate transfer device 70 is supported on rollers 79a, 79b, 79c, 79d and 79e, and rotationally driven in the clockwise direction at the same peripheral rate as photoreceptor 1.

While the yellow toner image as the first color image, having been formed and carried on photoreceptor 1, passes the nip portion between the photoreceptor 1 and the intermediate transfer device 70, the image is successively subjected to intermediate transfer (primary transfer) onto the outer circumference surface of the intermediate transfer device 70 under an electric field produced by a primary transfer bias applied to the intermediate transfer device 70 from a primary transfer roller 5a.

Transfer of the yellow toner image as the first color toner image to the intermediate device 70 having been completed, the surface of photoreceptor 1 is cleaned by a cleaning device 6a.

Similarly, a magenta toner image as a second color toner image, a cyan toner image as a third color toner image, and a black toner image as a fourth color toner image are sequentially transferred onto the intermediate transfer device 70 in a superposed manner to form a superposed color toner image corresponding to a targeted color image.

A secondary transfer roller counter roller 79b is supported by a secondary transfer roller 5b, axes of both rollers being in parallel with each other, and the secondary transfer roller 5b is arranged under the intermediate transfer device 70 so that the roller 5b can be withdrawn from the secondary transfer roller counter roller 79b.

A primary transfer bias to carry out sequential superposition transfer of the first through fourth color toner images on the photoreceptor 1 onto the intermediate transfer device 70 has polarity opposite that of the toner, and is applied from a bias power source. The applied voltage is, for example, in the range of +100 V to +2 kV.

In the process of the primary transfer of the first through fourth color toner images on the photoreceptor 1 onto intermediate transfer device 70, it is also possible that the secondary transfer roller 5b and an intermediate transfer device cleaning device 6b are withdrawn from the intermediate transfer device 70.

The superposed color toner image having been transferred onto the intermediate transfer device 70 in the form of belt is transferred onto a recording sheet P as a second image carrier as follows. The secondary transfer roller 5b is brought into contact with the belt of the intermediate transfer device 70 and the recording sheet P is fed at specified timing to the nip between the belt of the intermediate transfer device 70 and the secondary transfer roller 5b through a recording sheet transfer guide from a pair of sheet feed registration rollers 23. A secondary transfer bias is applied to the secondary transfer roller 5b by a bias power source, whereby the superposed color toner image is transferred from the intermediate transfer device 70 onto the recording sheet P as a second image carrier (secondary transfer). Recording sheet P with a transferred toner image is conveyed to a fixing device 24, where the toner image is thermally fixed.

The image formation apparatus of the present invention is applied to common electrophotographic apparatuses such as electrophotographic copiers, laser printers, LED printers, or liquid crystal shutter-type printers. In addition, it can be widely applied for display, recording, short-run printing, plate making, facsimile, etc., to which electrophotographic technology is applied.

### Examples

Next, the invention will be explained employing examples, but the invention is not specifically limited thereto. The term “parts” means “parts by mass”, unless otherwise specified.

### Preparation of Photoreceptor 1

The photoreceptor 1 was prepared as follows.

The cylinder-shaped aluminum support surface was subjected to cutting to obtain a conductive support having a surface roughness Rz of 1.5 μm.

### <Intermediate Layer>

The following intermediate layer coating composition was prepared.

Polyamide resin X1010 (manufactured by Daicel-Degussa Ltd.) 1 part
Titanium oxide SMT500SAS (manufactured by TAYCA CORPORATION) 1.1 parts
Ethanol 20 parts

The composition was dispersed in a batch process for ten hours employing a sand mill as a dispersion apparatus.

The coating composition was applied onto the conductive support by means of an immersion coating method, and dried for 20 minutes at 110° C. so as to form an intermediate layer having a thickness of 2 μm.

### <Charge Generation Layer>

Charge generation material, titanyl phthalocyanine pigment, 20 parts (titanyl phthalocyanine pigment having a maximum diffraction peak at least at a position of 27.3° in the Cu—Kα characteristic X-ray diffraction spectra)
Polyvinyl butyral resin 10 parts (#6000-C, manufactured by Denki Kagaku Kogyo Co., Ltd.)
t-Butyl acetate 700 parts
4-Methoxy-4-methyl-2-pentanone 300 parts

The above components were mixed and dispersed in a sand mill for ten hours to prepare a charge generation layer coating solution. The coating solution was coated on the intermediate layer by means of an immersion coating method so as to form a charge generation layer having a dry thickness of 0.3 μm.

### <Charge Transport Layer>

Charge transport material: CTM (Compound A described below) 150 parts
Binder: Polycarbonate 300 parts (Z300: manufactured by Mitsubishi Gas Chemical Company, Inc.)
Anti-oxidant (Irganox 1010, manufactured by Ciba Japan Co., Ltd.) 6 parts
Toluene/Tetrahydrofuran (1/9 by volume) 2000 parts
Silicone oil (KF-54, manufactured by Shin-Etsu Chemicals Co., Ltd.) 1 part

The above listed components were mixed to prepare a charge transport layer coating solution. The coating solution was coated on the charge generation layer by means of an immersion coating method, and dried at 110° C. for 60 minutes to form a charge transport layer having a dry thickness of 20 μm.

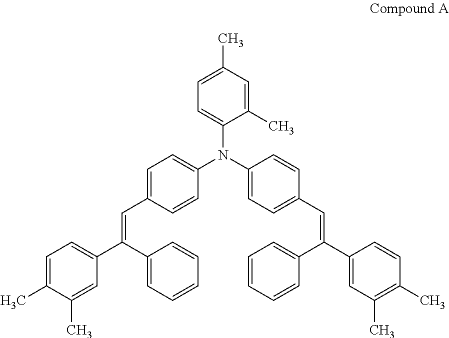

### <Protective Layer>

Titanium Oxide Particles surface treated with hole transport compound 100 parts (Titanium oxide with a number average primary particle size of 6 nm surface treated with S-15 in the same mass as the titanium oxide)
Curable Compound (Exemplified Compound Mc-31) 100 parts
Isopropyl alcohol 500 parts

The above components were mixed, and dispersed in a sand mill for ten hours. Then, 30 parts of polymerization initiator 1-6 were added to the resulting dispersion and mixed with stirring under light shielded conditions to prepare a protective layer coating solution. (The coating solution was light shielded during storage.) This coating solution was coated on the charge transport layer of the photoreceptor obtained above by means of a circular slide hopper coating apparatus, dried at room temperature for 20 minutes (solvent evaporation drying process), and irradiated for 1 minute with a metal halide lamp (500 W) at the position 100 mm distant from the coated surface while rotating the conductive support (ultraviolet ray curing process) to form a protective layer having a thickness of 3 μm. Thus, Photoreceptor 1 was prepared.

Preparation of Photoreceptors 2 through 12

Photoreceptors 2 through 12 were prepared in the same manner as the Photoreceptor 1 above, except that materials used in the protective layer and/or curing conditions were changed as shown in Table 1.

### Preparation of Photoreceptor 13

Photoreceptor 13 was prepared in the same manner as the Photoreceptor 1, except that the titanium oxide particles surface processed with the hole transport compound was not used in the protective layer.

### Preparation of Photoreceptor 14

Photoreceptor 14 was prepared in the same manner as the Photoreceptor 1, except that the protective layer was formed according to the following procedures.

### <Protective Layer>

Titanium Oxide Particles surface treated with hole transport compound 100 parts (Titanium oxide with a number average primary particle size of 6 nm surface treated with S-15 in the same mass as the titanium oxide)
Binder (Polycarbonate PC having the following chemical structure, having a weight average molecular weight of 20,000) 100 parts
Isopropyl alcohol 500 parts

The above components were mixed, and dispersed in a sand mill for ten hours to prepare a protective layer coating solution. This coating solution was coated on the charge transport layer of the photoreceptor obtained above by means of a circular slide hopper coating apparatus, dried at 100° C. for 50 minutes to form a protective layer having a thickness of 3 μm.

### PC

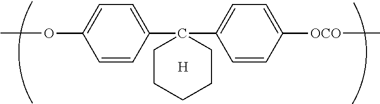

TABLE 1

| | | | | Surface Processed Inorganic Particles | | | | | | | | |
|---|---|---|---|---|---|---|---|---|---|---|---|---|
| | | | | | Number | | | Amount | | | | |
| | Radical Polymerizable | | | | Average | | | used of | Polymerization | | | |
| | Compound | | | | Primary | Surface | | Metal | Initiator | | | |
| Photo- | | Amount | Functional | | Particle | Process- | | Oxide | | Amount | | |
| receptor | Exemplified | used | Goup | Metal Oxide | Diameter | ing | | Particles | Exemplified | used | Curing | |
| No. | Compound | (Parts) | Number | Particles | (nm) | Agent | a) | (Parts) | Compound | Parts | Condition | Remarks |
| 1 | Mc-31 | 100 | 4 | Titanium Oxide | 6 | S-15 | 100 | 100 | 1-6 | 30 | b) Light | Inv. |
| 2 | Mc-7 | 100 | 6 | Alumina | 6 | S-15 | 100 | 100 | 1-6 | 30 | ″ | Inv. |
| 3 | Mc-1 | 100 | 3 | Zinc Oxide | 6 | S-15 | 100 | 100 | 1-6 | 30 | ″ | Inv. |
| 4 | Mc-9 | 100 | 3 | Tin Oxide | 6 | S-15 | 100 | 100 | 1-6 | 30 | ″ | Inv. |
| 5 | Ac-7 | 100 | 6 | Titanium Oxide | 10 | S-24 | 100 | 100 | 1-6 | 30 | ″ | Inv. |
| 6 | Mc-31 | 100 | 4 | Alumina | 10 | S-24 | 100 | 100 | 1-6 | 30 | ″ | Inv. |
| 7 | Mc-31 | 100 | 4 | Zinc Oxide | 10 | S-24 | 100 | 100 | 5-1 | 30 | c) Heat | Inv. |
| 8 | Mc-9 | 100 | 6 | Tin Oxide | 10 | S-24 | 100 | 100 | 5-1 | 30 | ″ | Inv. |
| 9 | Mc-1 | 100 | 3 | Titanium Oxide | 30 | HTM-1 | 30 | 100 | 1-6 | 30 | Light | Inv. |
| 10 | Mc-1 | 100 | 3 | Alumina | 70 | S-6 | 10 | 100 | 1-6 | 30 | ″ | Inv. |
| 11 | Mc-1 | 100 | 3 | Zinc Oxide | 50 | S-6 | 100 | 100 | 1-6 | 15 | ″ | Inv. |
| 12 | Mc-31 | 100 | 4 | Tin Oxide | 100 | S-6 | 100 | 100 | 1-6 | 30 | ″ | Inv. |
| 13 | Mc-31 | 100 | 4 | — | — | — | | 100 | 1-6 | 30 | ″ | Inv. |
| 14 | PC | 100 | — | Titanium Oxide | 6 | S-15 | 100 | 100 | — | — | — | Comp. |

Inv.: Inventive;
Comp.: Comparative
a) Amount Used (Parts) of Surface Processing Agent to 100 Parts of Metal Oxide Particles
b) Light: The protective layer was cured employing a metal halide lamp (500 W) to give a thickness of 3 μm.
c) Heat: The protective layer was cured by heating at 140° C. for 30 minutes to give a thickness of 3 μm.

Toners added with an external additive and developers employing the same were prepared.

### (Preparation of Latex)

A solution in which 7.08 g of an anionic surfactant (sodium dodecyl benzene sulfonate: SDS) was dissolved in 2760 g of ion exchange water was incorporated in a 5000 ml separable flask equipped with a stiffer, a temperature sensor, a condenser and a nitrogen gas introducing device, and heated to 80° C. while stirring under nitrogen atmosphere. Separately, 72.0 g of Exemplified compound 19) were added to a mixture of 115.1 g of styrene, 42.0 g of n-butyl acrylate and 10.9 g of methacrylic acid, heated at 80° C. and dissolved, thereby preparing a monomer solution.

The solutions heated above were mixed and dispersed in a mechanical homogenizer provided with a circulation path to obtain an emulsion in which emulsified particles having a uniform dispersion particle diameter were dispersed. Subsequently, a solution in which 0.84 g of a polymerization initiator (potassium persulfate KPS) were dissolved in 200 g of ion exchange water was added to the emulsion, heated and stirred at 80° C. for three hours to obtain a polymer dispersion solution.

Successively, a solution in which 7.73 g of a polymerization initiator (KPS) were dissolved in 240 g of ion exchange water was further added to the resulting polymer dispersion solution, and fifteen minutes after the addition, a mixture solution of 383.6 g of styrene, 140.0 g of n-butyl acrylate, 36.4 g of methacrylic acid and 14.0 g of n-octyl 3-mercaptopropionate was dropwise added thereto at 80° C. in 120 minutes, then stirred for 60 minutes at that temperature, and cooled to 40° C. to obtain a latex dispersion solution. This latex dispersion solution was designated as Latex 1.

### (Preparation Example of Toner)

### Preparation of Toner Bk (Black Color)

In 160 ml of ion-exchange water, were dissolved 9.2 g of sodium n-dodecyl sulfate while stirring. This solution was gradually added with 20 g of REGAL® 330R (carbon black produced by Cabot Corporation) while stirring, and subsequently subjected to dispersion treatment by means of CLEARMIX, whereby a dispersion of colorant particles was prepared. The particle diameter of particles in the dispersion was measured employing an Electrophoresis Light Scattering Spectrophotometer, ELS-800 (produced by Otsuka Electronics Co., Ltd.). The weight average particle diameter of the particles was determined to be 112 nm. This dispersion was designated as Colorant Dispersion 1.

Latex 1 of 1250 g, 2000 ml of ion exchange water and Colorant Dispersion 1 obtained above were incorporated in a 5 liter four-necked flask equipped with a temperature sensor, a condenser, a nitrogen introducing device and a stirrer, and stirred. The resulting mixture was adjusted to 30° C., added with a 5 mole/liter sodium hydroxide aqueous solution to adjust the pH to 10.0.

Subsequently, the mixture was added with an aqueous solution, in which 52.6 g of magnesium chloride hexahydrate were dissolved in 72 ml of ion-exchange water, in 10 minutes while stirring at 30° C. After having been allowed to stand for 2 minutes, the mixture was heated to 90° C. in 5 minutes (at a rate of temperature rise of 12° C./minute). When the volume based median particle diameter (Dv 50) of the particles in the mixture reached 6.2 μm, the particle diameter being measured by means of Coulter Counter TA-II, the mixture was added with an aqueous solution in which 115 g of sodium chloride was dissolved in 700 ml of ion-exchange water to terminate particle growth, and further stirred at 85±2° C. for 8 hours to cause salting-out/fusion.

After that, the resulting mixture was cooled to 30° C. at a rate of 6° C./minute, added with hydrochloric acid to adjust to pH 2.0, and then stirring was stopped to produce colored particles. The resulting colored particles were filtered out and washed, and dried with a 40° C. air. Thus obtained colored particles were designated as Toner Bk. The volume based median particle diameter (Dv 50) of Toner Bk was 6.5 μm.

### Preparation of Toner Y, Toner M and Toner C

Toner Y was prepared in the same manner as Toner Bk, except that C. I. Pigment Yellow 185 was used instead of Regal 330R. The volume based median particle diameter (Dv 50) of Toner Y was 6.6 μm.

Toner M was prepared in the same manner as Toner Bk, except that C. I. Pigment Red 122 was used instead of Regal 330R. The volume based median particle diameter (Dv 50) of Toner M was 6.6 μm.

Toner C was prepared in the same manner as Toner Bk, except that C. I. Pigment Blue 15:3 was used instead of Regal 330R. The volume based median particle diameter (Dv 50) of Toner C was 6.7 μm.

The Toner Bk, Toner Y, Toner M and Toner C were subjected to the external additive processing as described later to obtain external additive processed Toners, Toners Bk-1 through Bk-11, Toner Y-1, Toner M-1 and Toner C-1.

### [External Additive Processing]

### Preparation of Toner Bk-1

One part of hydrophobic silica (with a number average primary particle diameter of 12 nm, and a hydrophobicity of 68), 1.2 parts of hydrophobic titanium oxide (number average primary particle diameter=20 nm, hydrophobicity=63) and 0.1 parts of an antioxidant (AO-1) were added to 100 parts of the toner particles constituting Toner Bk above in that order, mixed in a HENSCHEL MIXER (produced by Mitsui Miike Kakoki Co., Ltd.), and sieved with a 45 μm sieve to remove coarse particles, thereby preparing Toner Bk-1.

### Preparation of Toner Bk-2

Toner Bk-2 was prepared in the same manner as Toner Bk-1, except that an antioxidant AO-4 was used.

### Preparation of Toner Bk-3

Toner Bk-3 was prepared in the same manner as Toner Bk-1, except that 0.05 parts of an antioxidant AO-1 were added.

### Preparation of Toner Bk-4

Toner Bk-4 was prepared in the same manner as Toner Bk-1, except that 0.2 parts of an antioxidant AO-6 were added.

### Preparation of Toner Bk-5

Toner Bk-5 was prepared in the same manner as Toner Bk-1, except that 2.0 parts of an antioxidant AO-6 were added.

### Preparation of Toner Bk-6

Toner Bk-6 was prepared in the same manner as Toner Bk-1, except that 0.4 parts of an antioxidant AO-8 were added.

### Preparation of Toner Bk-7

Toner Bk-7 was prepared in the same manner as Toner Bk-1, except that an antioxidant AO-15 was added.

### Preparation of Toner Bk-8

Toner Bk-8 was prepared in the same manner as Toner Bk-1, except that 0.5 parts of an antioxidant AO-18 were added.

### Preparation of Toner Bk-9

Toner Bk-9 was prepared in the same manner as Toner Bk-1, except that 0.4 parts of ascorbic acid were added as an antioxidant.

### Preparation of Toner Bk-10

Toner Bk-10 was prepared in the same manner as Toner Bk-1, except that 0.4 parts of tocopherol were added as an antioxidant.

### Preparation of Toner Bk-11 (Comparative Toner)

Toner Bk-11 was prepared in the same manner as Toner Bk-1, except that the antioxidant was not added.

### Preparation of Toner Y-1

One part of hydrophobic silica (with a number average primary particle diameter of 12 nm, and a hydrophobicity of 68), 1.2 parts of hydrophobic titanium oxide (with a number average primary particle diameter of 20 nm, and a hydrophobicity of 63) and 0.1 parts of an antioxidant (AO-1) were added to 100 parts of the toner particles constituting Toner Y above in that order, mixed in a HENSCHEL MIXER (produced by Mitsui Miike Kakoki Co., Ltd.), and sieved with a 45 μm sieve to remove coarse particles, thereby preparing Toner Y-1.

### Preparation of Toner M-1

One part of hydrophobic silica (with a number average primary particle diameter of 12 nm, and a hydrophobicity of 68), 1.2 parts of hydrophobic titanium oxide (with a number average primary particle diameter of 20 nm, and a hydrophobicity=63) and 0.1 parts of an antioxidant (AG-1) were added to 100 parts of the toner particles constituting Toner M above in that order, mixed in a HENSCHEL MIXER (produced by Mitsui Miike Kakoki Co., Ltd.), and sieved with a 45 μm sieve to remove coarse particles, thereby preparing Toner M-1.

### Preparation of Toner C-1

One part of hydrophobic silica (with a number average primary particle diameter of 12 nm, and a hydrophobicity of 68), 1.2 parts of hydrophobic titanium oxide (with a number average primary particle diameter of 20 nm, and a hydrophobicity=63) and 0.1 parts of an antioxidant (AO-1) were added to 100 parts of the toner particles constituting Toner C above in that order, mixed in a HENSCHEL MIXER (produced by Mitsui Miike Kakoki Co., Ltd.), and sieved with a 45 μm sieve to remove coarse particles, thereby preparing Toner C-1.

### Preparation of Toner Y-2

Toner Y-2 was prepared in the same manner as Toner Y-1, except that the antioxidant (AO-1) was not added.

### Preparation of Toner M-2

Toner M-2 was prepared in the same manner as Toner M-1, except that the antioxidant (AO-1) was not added.

### Preparation of Toner C-2

Toner C-2 was prepared in the same manner as Toner C-1, except that the antioxidant (AO-1) was not added.

It was confirmed that there was no substantial difference in the volume based median particle diameter (Dv 50) of the toners between before and after the external additive processing.

The details of the external additive processing of each toner are shown in Table 2.

TABLE 2

| | | | External Additives | | | | |
|---|---|---|---|---|---|---|---|
| | | | | Hydrophobic | | | |
| | | Toner | Hydrophobic Silica | Titanium oxide | | | |
| | | Particle | Number Average | Number Average | | | |
| | | Diameter | Primary Particle | Primary Particle | | Addition Amount (Parts) | |
| Developer | | Dv50 | Diameter | Diameter | Antioxidant | of Antioxidant to 100 | |
| No. | Toner No. | (μm) | (nm) | (nm) | (Kinds) | Parts of Toner | Remarks |
| Bk-1 | Bk-1 | 6.5 | 12 | 20 | AO-1 | 0.100 | Inventive |
| Bk-2 | Bk-2 | 6.5 | 12 | 20 | AO-4 | 0.100 | Inventive |
| Bk-3 | Bk-3 | 6.5 | 12 | 20 | AO-1 | 0.050 | Inventive |
| Bk-4 | Bk-4 | 6.5 | 12 | 20 | AO-6 | 0.200 | Inventive |
| Bk-5 | Bk-5 | 6.5 | 12 | 20 | AO-6 | 2.000 | Inventive |
| Bk-6 | Bk-6 | 6.5 | 12 | 20 | AO-8 | 0.400 | Inventive |
| Bk-7 | Bk-7 | 6.5 | 12 | 20 | AO-15 | 0.100 | Inventive |
| Bk-8 | Bk-8 | 6.5 | 12 | 20 | AO-18 | 0.500 | Inventive |
| Bk-9 | Bk-9 | 6.5 | 12 | 20 | Ascorbic Acid | 0.400 | Inventive |
| Bk-10 | Bk-10 | 6.5 | 12 | 20 | Tocopherol | 0.400 | Inventive |
| Bk-11 | Bk-11 | 6.5 | 12 | 20 | — | — | Comparative |
| Y-1 | Y-1 | 6.6 | 12 | 20 | AO-1 | 0.100 | Inventive |
| M-1 | M-1 | 6.6 | 12 | 20 | AO-1 | 0.100 | Inventive |
| C-1 | C-1 | 6.7 | 12 | 20 | AO-1 | 0.100 | Inventive |
| Y-2 | Y-2 | 6.6 | 12 | 20 | — | — | Comparative |
| M-2 | M-2 | 6.6 | 12 | 20 | — | — | Comparative |
| C-2 | C-2 | 6.7 | 12 | 20 | — | — | Comparative |

### [Preparation of Developer]

Six parts of each of Toners Bk-1 through Bk-11, Toner Y-1, Toner M-1, Toner C-1, Toner Y-2, Toner M-2, and Toner C-2 were mixed with 100 parts of a ferrite carrier coated with styrene-methacrylate copolymer having a volume based median diameter (Dv 50) of 45 μm to prepare Developers Bk-1 through Bk-11, Developer Y-1, Developer M-1, Developer C-1, Developer Y-2, Developer M-2, and Developer C-2 for evaluation, respectively.

The photoreceptors and developers obtained above having been combined as shown in Table 3, Combination Nos. 1 through 20 were prepared, and evaluated employing a 780 nm semiconductor laser of 600 dpi and a commercially available full color multifunction peripheral bizhub PRO C6500 (manufactured by Konica Minolta Business Technologies Co., Ltd.) having the structure as shown in FIG. 2. The full color multifunction peripheral had four sets of image formation units, and evaluation was carried out employing a full color multifunction peripheral having four sets of image formation units having the same photoreceptor. (For example, when Photoreceptor 1 was employed, the four sets of the image formation units employed Photoreceptor 1.) An A4 size image with a printing ratio of 2.5% for each color of YMCK was printed on five hundred thousand sheets of A4 size neutralized paper at 30° C. and at 80% RH. After that, evaluation was carried out under the following respective conditions.

### Fog Density (Evaluation of Black-and-White Image)

Evaluation was carried out after five hundred thousand copies were printed at 30° C. and 80% RH as described above. Fog density of solid white image was measured in terms of reflection density by means of a Densitometer RD-918 produced by Macbeth Co. Ltd. The reflection density was represented in terms of relative density to the reflection density at non-image portions of an A4 paper sheet being measured 0.000.

A: Density is less than 0.010 (Good).
B: Density is from 0.010 to 0.020 or less (which is practically acceptable).
C: Density is more than 0.020 (which is practically unacceptable).

### (Image Blur)

Immediately after five hundred thousand copies were printed at 30° C. and 80% RH, the printer was turned off, and after 12 hours, the printer was turned on again. When the printer reached a printable mode, a halftone image (with a relative reflection density of 0.4 measured by a Macbeth densitometer) and a 6 dot lattice image were printed on the entire surface of an A3 size neutralized paper. The resulting printed images were visually observed and evaluated according to the following criteria.

A: No image blur is observed in the halftone image nor in the lattice image. (Good)
B: A slight density decrease is observed in a band form in the major axis direction of the photoreceptor only in the halftone image (which is practically acceptable).
C: Image loss and line reduction in the lattice image due to image blur are observed (which is practically unacceptable).

### (Evaluation of Halftone Color Image)

After five hundred thousand copies were printed at 30° C. and 80% RH, the printer was left for 1 hour under an ambience of 20° C., and 50% RH. After that, a halftone color image including a portrait photograph was printed on A4 size paper by applying the four image forming units of the full color multifunction peripheral bizhub PRO C6500. The resulting printed images were observed and ranked according to the following criteria:

A: The halftone color image is smoothly reproduced and neither image blur nor image unevenness is observed. (Good)
B: Image unevenness or a slight image blur is observed partially in the halftone color image, but it is not so noticeable, and the halftone color image is smoothly reproduced as a whole (practically acceptable).
C: Image blur or image unevenness is observed in the halftone color image (practically unacceptable).

### (Wear Resistance of Photoreceptor)

The thickness of the coating layer of the photoreceptor comprised of the intermediate layer, the charge generation layer, the charge transfer layer and the protective layer was measured before and after five hundred thousand copies were printed at 30° C. and 80% RH as described above. The thickness of the coating layer was measured randomly at ten points on the uniform thickness portion (except for a region located within 3 cm from both ends, because the coating layer thickness becomes uneven at both ends thereof), and the average of the ten measurements was defined as the layer thickness of the coating layer. An eddy current thickness meter EDDY 560C (produced by HELMUT FISHER GMBTE Co. Ltd.) was employed as a layer thickness measuring instrument, and the layer thickness difference in the coating layer between before and after printing was determined and evaluated as a measure of wear resistance of the photoreceptor.

A: The layer thickness difference is less than 0.8 μm (Good).
B: The layer thickness difference is from 0.8 to 2 μm (practically acceptable).
C: The layer thickness difference is more than 2 μm (practically unacceptable).

The results are collectively shown in Table 3.

TABLE 3

| | | | Evaluation | | | | |
|---|---|---|---|---|---|---|---|
| | | | | | Halftone | Wear Resistance | |
| Combination | Photoreceptor | Developer | | Image | Color | of | |
| No. | No. | (Toner) No. | Fog | Blur | Image | Photoreceptor | Remarks |
| 1 | 1 | Bk-1, Y-1, | A | A | A | A | Inventive |
| | | M-1, C-1 | | | | | |
| 2 | 2 | Bk-2, Y-1, | A | A | A | A | Inventive |
| | | M-1, C-1 | | | | | |
| 3 | 3 | Bk-3, Y-1, | A | A | A | A | Inventive |
| | | M-1, C-1 | | | | | |
| 4 | 4 | Bk-4, Y-1, | A | B | A | A | Inventive |
| | | M-1, C-1 | | | | | |
| 5 | 5 | Bk-5, Y-1, | A | B | A | B | Inventive |
| | | M-1, C-1 | | | | | |
| 6 | 6 | Bk-1, Y-1, | A | A | A | A | Inventive |
| | | M-1, C-1 | | | | | |
| 7 | 7 | Bk-2, Y-1, | A | A | A | A | Inventive |
| | | M-1, C-1 | | | | | |
| 8 | 8 | Bk-3, Y-1, | A | A | A | A | Inventive |
| | | M-1, C-1 | | | | | |
| 9 | 9 | Bk-4, Y-1, | A | B | A | A | Inventive |
| | | M-1, C-1 | | | | | |
| 10 | 10 | Bk-5, Y-1, | A | A | A | A | Inventive |
| | | M-1, C-1 | | | | | |
| 11 | 11 | Bk-1, Y-1, | A | A | A | A | Inventive |
| | | M-1, C-1 | | | | | |
| 12 | 12 | Bk-1, Y-1, | A | A | A | A | Inventive |
| | | M-1, C-1 | | | | | |
| 13 | 13 | Bk-1, Y-1, | A | A | B | B | Inventive |
| | | M-1, C-1 | | | | | |
| 14 | 1 | Bk-6, Y-1, | A | A | A | A | Inventive |
| | | M-1, C-1 | | | | | |
| 15 | 1 | Bk-7, Y-1, | A | A | A | A | Inventive |
| | | M-1, C-1 | | | | | |
| 16 | 1 | Bk-8, Y-1, | A | B | A | A | Inventive |
| | | M-1, C-1 | | | | | |
| 17 | 1 | Bk-9, Y-1, | A | A | A | A | Inventive |
| | | M-1, C-1 | | | | | |
| 18 | 1 | Bk-10, Y-1, | A | A | A | A | Inventive |
| | | M-1, C-1 | | | | | |
| 19 | 14 | Bk-1, Y-1, | A | B | B | C | Comparative |
| | | M-1, C-1 | | | | | |
| 20 | 1 | Bk-11, Y-2, | A | C | C | A | Comparative |
| | | M-2, C-2 | | | | | |

As is apparent from Table 3, inventive combinations 1 through 18 provide Ranking A or B (good or practically acceptable results) in all of the items evaluated, however, comparative combinations Nos. 19 and 20 provide Ranking C (practically unacceptable results) in any of the items evaluated, the former employing a protective layer falling outside the scope of the invention and the latter employing a toner containing no antioxidant.

### Preparation of Photoreceptor 21

Photoreceptor 21 was prepared in the same manner as Photoreceptor 1, except that the protective layer was replaced with a protective layer as described below.

γ-Glycidoxypropyltrimethoxysilane of 59 g and 32 g of dimethoxysilane were dissolved in 35 g of ethanol to obtain a solution. The resulting solution was added with 26 g of dihydroxymethyltriphenylamine (a compound represented by formula T-1 below), 1 g of an antioxidant (antioxidant AO-1) and 1 g of alumichelate (Alumichelate A (W), produced by Kawaken Chemical Co., Ltd.) to prepare a coating solution. The resulting coating solution was coated on the charge transport layer of the Photoreceptor 1 to form a siloxane resin protective layer with a dry thickness of 3 μm, followed by heat curing treatment at 120° C. for one hour. Thus, Photoreceptor 21 was prepared.

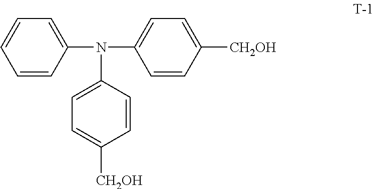

A combination of Photoreceptor 21 with Developers Bk-1, Y-1, M-1 and C-1 (Combination No. 21) was evaluated in the same manner as Combination No. 1. The evaluation results are shown in Table 4.

TABLE 4

| | | | Evaluation | | | | |
|---|---|---|---|---|---|---|---|
| | Photo- | | | | Halftone | Wear | |
| Combination | receptor | Developer | | Image | Color | Resistance of | |
| No. | No. | (Toner) No. | Fog | Blur | Image | Photoreceptor | Remarks |
| 21 | 21 | Bk-1, Y-1, | A | B | A | A | Inventive |
| | | M-1 and C-1 | | | | | |

As is apparent from Table 4, the photoreceptor comprising a siloxane resin protective layer containing a siloxane resin prepared by condensation reaction markedly exhibits the effects of the invention.

### Preparation of Photoreceptor 22

Photoreceptor 22 was prepared in the same manner as Photoreceptor 1, except that the protective layer was replaced with a protective layer as described below.

Two hundred and twenty-eight parts of a polyol having a number average molecular weight of 800 prepared by open ring polymerization of bishydroxyethyl terephthalate with ε-caprolactone, 8.1 parts of 1,4-butanediol, 15.0 parts of trimethylolpropane, 1012.8 parts of cyclohexanone and 0.034 parts of dibutyltin dioctoate are uniformly mixed, then added with 160 parts of 4,4′-diphenylmethane diisocyanate and 20 parts of titanium oxide surface treated with dimethoxysilane, and dispersed. The resulting dispersion solution was coated on the charge transport layer of the Photoreceptor 1 to form a polyurethane resin protective layer with a dry thickness of 3 μm, followed by heat curing treatment at 120° C. for three hours. Thus, Photoreceptor 22 was prepared.

A combination of Photoreceptor 22 with Developers Bk-1, Y-1, M-1 and C-1 (Combination No. 22) was evaluated in the same manner as Combination No. 1. The evaluation results are shown in Table 5.

TABLE 5

| | | | Evaluation | | | | |
|---|---|---|---|---|---|---|---|
| | Photo- | | | | Halftone | Wear Resistance | |
| Combination | receptor | Developer | | Image | Color | of | |
| No. | No. | (Toner) No. | Fog | Blur | Image | Photoreceptor | Remarks |
| 22 | 22 | Bk-1, Y-1, | A | B | A | B | Inventive |
| | | M-1 and C-1 | | | | | |

As is apparent from Table 5, the photoreceptor comprising a polyurethane resin protective layer containing a polyurethane resin prepared by condensation reaction markedly exhibits the effects of the invention.

Next, a toner containing toner particles internally added with an antioxidant and a developer employing the toner were prepared.

### Preparation of Toner BkN (Black)

In 160 ml of ion-exchange water were dissolved 9.2 g of sodium n-dodecyl sulfate while stirring. This solution was gradually added with 20 g of REGAL® 330R (carbon black produced by Cabot Corporation) and 2 g of an antioxidant (AO-1) while stirring, and subsequently subjected to a dispersion treatment by means of CLEARMIX, whereby a dispersion of colorant particles was prepared. The particle diameter of particles in the dispersion was measured employing an Electrophoresis Light Scattering Spectrophotometer, ELS-800 (produced by Otsuka Electronics Co., Ltd.). The weight average particle diameter of the particles was determined to be 112 nm. This dispersion was designated as Colorant Dispersion 2.

Latex 1 of 1250 g, 2000 ml of ion exchange water and Colorant Dispersion 2 were charged in a 5 liter four-necked flask equipped with a temperature sensor, a condenser, a nitrogen introducing device and a stirrer, and stiffed. The resulting mixture was adjusted to 30° C., added with a 2 mole/liter sodium hydroxide aqueous solution to adjust the pH to 10.0.

Subsequently, the mixture was added with an aqueous solution, in which 52.6 g of magnesium chloride hexahydrate was dissolved in 72 ml of ion-exchange water, in 5 minutes while stirring at 30° C. After being allowed to stand for 2 minutes, the mixture was heated to 90° C. in 5 minutes (at a rate of temperature rise of 12° C./minute). When the volume based median particle diameter (Dv 50) of the particles in the mixture reached 4.7 μl, the particle diameter being measured by means of Coulter Counter TA-II, the mixture was added with an aqueous solution in which 115 g of sodium chloride was dissolved in 700 ml of ion-exchange water to terminate the particle growth, and further stirred at 85±2° C. for 8 hours to cause salting-out/fusion.

The resulting mixture was cooled to 30° C. at a rate of 6° C./minute, added with hydrochloric acid to adjust to pH 2.0, and then stirring was stopped to produce colored particles. The resulting colored particles were filtered out and washed, and dried with a 40° C. air. Thus obtained colored particles were designated as Toner BkN. The volume based median particle diameter (Dv 50) of Toner BkN was 5.2 p.m.

### Preparation of Toner YN, Toner MN and Toner CN

Toner YN was prepared in the same manner as Toner BkN, except that C. I. Pigment Yellow 185 was used instead of Regal 330R. The volume based median particle diameter (Dv 50) of Toner YN was 5.3 μm.

Toner MN was prepared in the same manner as Toner BkN, except that C. I. Pigment Red 122 was used instead of Regal 330R. The volume based median particle diameter (Dv 50) of Toner MN was 5.2 μm.

Toner CN was prepared in the same manner as Toner BIN, except that C. I. Pigment Blue 15:3 was used instead of Regal 330R. The volume based median particle diameter (Dv 50) of Toner CN was 5.2 μm.

The Toner BkN, Toner YN, Toner MN and Toner CN were subjected to the external additive processing as described below to obtain external additive processed Toners, Toner BkN-50, Toner YN-50, Toner MN-50 and Toner CN-50.

### [External Additive Processing]

### Preparation of Toner BkN-50

One part of hydrophobic silica (with a number average primary particle diameter of 12 nm, and a hydrophobicity of 68), and 12 parts of hydrophobic titanium oxide (with a number average primary particle diameter of 20 nm, and a hydrophobicity of 63) were added to 100 parts of the toner particles constituting Toner BkN above in that order, mixed in a HENSCHEL MIXER (produced by Mitsui Miike Kakoki Co., Ltd.), and sieved with a 45 μm sieve to remove coarse particles, thereby preparing Toner BkN-50.

### Preparation of Toner YN-50

One part of hydrophobic silica (with a number average primary particle diameter of 12 nm, and a hydrophobicity of 68) and 1.2 parts of hydrophobic titanium oxide (with a number average primary particle diameter of 20 nm, and a hydrophobicity of 63) were added to 100 parts of the toner particles constituting Toner YN above in that order, mixed in a HENSCHEL MIXER (produced by Mitsui Miike Kakoki Co., Ltd.), and sieved with a 45 μm sieve to remove coarse particles, thereby preparing Toner YN-50.

### Preparation of Toner MN-50

One part of hydrophobic silica (with a number average primary particle diameter of 12 nm, and a hydrophobicity of 68) and 1.2 parts of hydrophobic titanium oxide (with a number average primary particle diameter of 20 nm, and a hydrophobicity of 63) were added to 100 parts of the toner particles constituting Toner MN above in that order, mixed in a HENSCHEL MIXER (produced by Mitsui Miike Kakoki Co., Ltd.), and sieved with a 45 μm sieve to remove coarse particles, thereby preparing Toner MN-50.

### Preparation of Toner CN-50

One part of hydrophobic silica (with a number average primary particle diameter of 12 nm, and a hydrophobicity of 68) and 1.2 parts of hydrophobic titanium oxide (with a number average primary particle diameter=of 20 nm, and a hydrophobicity of 63) were added to 100 parts of the toner particles constituting Toner CN above in that order, mixed in a HENSCHEL MIXER (produced by Mitsui Miike Kakoki Co., Ltd.), and sieved with a 45 μm sieve to remove coarse particles, thereby preparing Toner CN-50.

### [Preparation of Developer]

Six parts of each of Toners BkN-50, Toner YN-50, Toner MN-50, and Toner CN-50 were mixed with 100 parts of a ferrite carrier coated with styrene-methacrylate copolymer having a volume based median diameter (Dv 50) of 45 μm to prepare Developers BkN-50, Developer YN-50, Developer MN-50 and Developer CN-50 for evaluation, respectively.

A combination of Photoreceptor 1 with Developers BkN-50, YN-50, MN-50 and CN-50 (Combination No. 23) was evaluated in the same manner as Combination No. 1. The evaluation results are shown in Table 6.

TABLE 6

| | | | Evaluation | | | | |
|---|---|---|---|---|---|---|---|
| | Photo- | | | | Halftone | Wear Resistance | |
| Combination | receptor | Developer | | Image | Color | of | |
| No. | No. | (Toner) No. | Fog | Blur | Image | Photoreceptor | Remarks |
| 23 | 1 | BkN-50, YN-50, | A | B | B | A | Inventive |
| | | MN-50 and CN-50 | | | | | |

As is apparent from Table 6, the toner internally added with an antioxidant provides the effects of the invention.

What is claimed is:

1. An image formation method comprising the steps of
charging an organic photoreceptor by a charging device, the photoreceptor comprising a substrate and provided thereon, a photoreceptive layer and a protective layer in that order;
imagewise exposing the charged organic photoreceptor by an exposure device to form an electrostatic latent image;
developing the electrostatic latent image by a developing device to form a toner image, the developing device comprising a developer containing a toner;
transferring the toner image to a recording medium by a transfer device; and
then removing, by a cleaning device, a toner remaining on the organic photoreceptor from the organic photoreceptor,
wherein the protective layer is formed by polymerization of a polymerizable composition containing a polymerizable compound with a polymerizable functional group, and wherein the toner contains an antioxidant.

2. The image formation method of claim 1, wherein the antioxidant is added to the toner as a mixture.

3. The image formation method of claim 1, wherein the antioxidant includes a hindered phenol compound.

4. The image formation method of claim 2, wherein the antioxidant is added to the toner as a mixture in an amount of from 0.005 to 10 parts by mass based on 100 parts by mass of the toner before addition of the antioxidant.

5. The image formation method of claim 1, wherein the polymerizable functional group of the polymerizable compound is selected from an unsaturated polymerizable functional group, a ring-opening polymerizable functional group or an isomerisation polymerizable functional group.

6. The image formation method of claim 5, wherein the polymerizable functional group of the polymerizable compound is the unsaturated polymerizable functional group.

7. The image formation method of claim 6, wherein the unsaturated polymerizable functional group is an acryloyl group (CH₂═CHCO—) or a methacryloyl group (CH₂═CCH₃CO—).

8. The image formation method of claim 1, wherein the polymerizable compound in the polymerizable composition includes a polymerizable compound with at least three of the polymerizable functional group.

9. The image formation method of claim 8, wherein the content in the polymerizable composition of the polymerizable compound with at least three of the polymerizable functional group is 50% by mass or more of the total amount of the polymerizable compound used.

10. The image formation method of claim 1, wherein the protective layer further contains metal oxide particles.

11. The image formation method of claim 10, wherein the metal oxide particles are selected from titanium oxide particles, alumina particles, zinc oxide particles, and tin oxide particles.

12. The image formation method of claim 10, wherein the metal oxide particles have a number average primary particle diameter of from 3 to 100 nm.

13. The image formation method of claim 10, wherein the metal oxide particles are surface-processed with a surface-processing agent.

14. The image formation method of claim 13, wherein the surface-processing agent includes a silane coupling agent or a titanium coupling agent.

15. The image formation method of claim 13, wherein the surface-processing agent includes a chain polymerizable compound having a surface-processing group.

16. The image formation method of claim 10, wherein the metal oxide particle content of the protective layer is from 10 to 200 parts by mass, based on 100 parts by mass of binder resin.

17. The image formation method of claim 1, wherein the thickness of the protective layer is from 0.2 to 10 μm.

18. An image formation apparatus comprising:
an organic photoreceptor comprising a substrate and provided thereon, a photoreceptive layer and a protective layer in that order;
a charging device for charging the organic photoreceptor;
an exposure device for exposing a charged organic photoreceptor to form an electrostatic latent image on the organic photoreceptor;
a developing device for developing the electrostatic latent image to form a toner image on the organic photoreceptor; the developing device comprising a developer containing a toner;
a transfer device for transferring the toner image from the organic photoreceptor to a recording medium; and
a cleaning device for removing a toner remaining on the organic photoreceptor from the organic photoreceptor,
wherein the protective layer is formed by polymerization of a polymerizable composition containing a polymerizable compound having a polymerizable functional group, and wherein the toner contains an antioxidant.
